(19) United States
(12) Patent Application Publication
(10) Pub. No.: US 2013/0224486 A1
(43) Pub. Date: Aug. 29, 2013

(54) PLASTIC FEEDSTOCK AND METHOD OF PREPARING THE SAME

(71) Applicant: Community Energy Systems, (US)

(72) Inventors: Elbert Branscomb, Urbana, IL (US); Allan Branscomb, Eugene, OR (US)

(73) Assignee: COMMUNITY ENERGY SYSTEMS, Boulder, CO (US)

(21) Appl. No.: 13/779,507

(22) Filed: Feb. 27, 2013

Related U.S. Application Data
(60) Provisional application No. 61/603,802, filed on Feb. 27, 2012.
(60) Provisional application No. 61/727,005, filed on Nov. 15, 2012.

(51) Int. Cl. C08J 11/06

(52) U.S. Cl. CPC C08J 11/06
USPC 428/402; 264/331.11; 264/331.13; 264/331.14; 264/331.19; 264/331.17; 264/331.22; 264/115; 264/101; 264/176.1; 264/211.23; 264/211.21; 264/177.1; 264/138; 264/29.1; 525/166; 428/357

(57) ABSTRACT

The invention provides systems and methods for preparing a plastic containing feedstream for conversion to valuable carbon-containing products such as synthetic crude oil. In some systems and methods, the plastic material is prepared from carpet scrap.

### CROSS REFERENCE TO RELATED APPLICATION

This application claims the benefit of priority under 35 U.S.C. §119(e) to U.S. Provisional Patent Application Ser. No. 61/603,802 filed Feb. 27, 2012, and U.S. Provisional Patent Application Ser. No. 61/727,005 filed Nov. 15, 2012. The entire contents of each of the foregoing applications are incorporated herein by reference.

### TECHNICAL FIELD

The invention relates to creating a high value feed stream of plastic and plastic-containing materials to be used for the efficient and economical conversion to solids, crude oils, synthesis gas and other valuable carbon-containing products and intermediates, commonly produced by thermal degradation processes. Specific embodiments relate to systems and methods for processing and preparing a feed stream from carpet, municipal solid waste, and other common plastic-containing waste streams, as well as co-mixing plastic-containing waste with biomass and agricultural waste to make a composite high value feed stream.

### BACKGROUND OF INVENTION

It is generally desirable to recycle/re-use waste materials. Recycling waste materials can preserve resources, reduce material and final product costs, reduce dependency on foreign oil, and reduce the costs and taxes associated with dumping waste materials. As reported by the U.S. Environmental Protection Agency, waste streams produced in the U.S. in 2010 included 14 million tons of container and packaging waste, 11 million tons of durable goods (e.g. appliances) and 7 million tons of non-durable goods (e.g. plates, cups). Only 8% of this waste was recovered for recycling. However, waste production is more than just a landfill problem. For example, the more than 37.5 million tons of plastic products and packaging produced in the United States every year poses a wide variety of dangers to human health and the environment. At every step in the production of plastics, hazardous substances are used and hazardous wastes are produced. Plastics are made from finite, nonrenewable petroleum and natural gas. Production of plastic products and packaging is one of the most chemically intensive manufacturing activities. According to the U.S. Environmental Protection Agency (EPA), 35 of the 47 chemical plants ranked highest in carcinogenic emissions are involved in plastic production. Workers at these chemical refineries (along with nearby residents), are at increased risk of injury or death due to toxic emissions and/or chemical explosions. Plastics contain additives (i.e. colorants, stabilizers, and plasticizers) that may include toxic constituents such as cadmium and lead. Some plastic chemicals, such as ethylene dichloride and vinyl chloride used to produce vinyl are considered to be carcinogenic. They may also trigger other health problems such as liver, kidney and neurological damage. Chemicals in plastics may reduce sperm counts. A panel convened by the National Institutes of Health found that the most commonly used plasticizer, DEHP, was a developmental toxin. Studies showed that male rodents exposed to DEHP had decreased sperm levels. DEHP, which is used in plastic food packaging, children's toys and medical devices, has the potential to leach out of plastics. Exposure can occur through breathing, ingestion and possibly through absorption of the skin.

Plastic litter and waste represents a significant and growing cost to the state, local government and ultimately ratepayers and taxpayers. Plastic represents 50 to 80 percent of the volume of litter collected from roads, parks and beaches, and 90 percent of floating litter in the marine environment. State and local agencies spend millions of dollars picking up litter each year, of which plastic is often the largest component.

Of hundreds of varieties of plastic, six are used in 60 percent of plastic production, including at least 90 percent of plastic packages and containers. Polyethylene terephthalate (PET or PETE) is found in beverage and food bottles and carpeting, and plastic wrap. High-density polyethylene (HDPE) is found in milk, water and juice bottles, trash and shopping bags; and in detergent, yogurt and margarine containers. Low density Polyethylene (LDPE) is used to make bread bags, frozen food bags and squeezable bottles. Polypropylene (PP) is used in carpeting, medicine and dairy product containers. Polystyrene (PS) is used to make packing foam, egg cartons, meat trays, aspirin bottles, plates, CD jackets and food service items.

But even focusing on these six plastics, most plastics cannot be economically retrieved in sufficient quantities to support the recycling market because of their varying physical and chemical properties. Therefore, different plastics are generally collected together for any recycling/reprocessing procedures. A number of problems can be encountered in attempting to recycle/re-use plastics material. Such waste material tends to have a very high relative volume and hence can incur significant transport costs. Problems can also be encountered with contaminants and also mixtures of different materials, and with disposing of various types of waste, which include plastics material such as used syringes from hospitals and other medical establishments.

In addition, common recycled wastes have low bulk densities (hereinafter “density”), making handling and processing more difficult and expensive. For example, uncompacted newspaper and magazine wastes have densities of about 19 lb/ft³. Compaction typically raises the density to only about 27 lb/ft³. The density of uncompacted plastic bottles can be as low as 1 lb/ft³. Compacting bottles rarely raises the density above 10 lb/ft³. Mixed plastic is even more difficult to compact, with maximum reported compacted density values typically less than 10 lb/ft³.

The difficulties encountered with raising the density of compacted wastes is due to the inability of common industrial waste compaction devices to effectively remove air from the solid. Compressing a solid is essentially a deaeration process. As a solid's volume fraction of air increases, the solid's density approaches that of air, or about 0.1 lb/ft³ (at atmospheric conditions). Conversely, the better a device can deaerate a solid and compress it, the higher the solid's final density, and the closer the compacted material approaches the density of its pure form.

The same applies for a material's thermal conductivity. Carbon steel has a thermal conductivity value of about 31 BTU/hr*ft*F, polypropylene about 0.9 BTU/hr*ft*F, and air only about 0.014 BTU/hr*ft*F. This is why fiber glass is such a good insulator; the glass fiber blanket prevents convective flow of air thru the blanket, resulting in stagnant air pockets that act as very effective insulators. Similarly, common recyclable wastes such as plastic bottles or carpet fiber, have considerable pore volumes and interstitial spaces which result in average solid thermal conductivities that are much lower than that of the pure solid, with all air removed.

Low values in both solid density and thermal conductivity are significant when the solid is used as feedstock in downstream manufacturing processes. Low densities result in inefficient volume utilization; e.g. equipment needs to be built bigger to handle the same mass flow rates. Similarly, in processes where heat transfer is important, in particular, processes involving the thermal degradation of solids (e.g. coal, biomass, plastic, agricultural waste, municipal solid waste, etc.), low thermal conductivities result in larger heat-transfer area requirements and/or longer residence times, both of which result in larger equipment, higher equipment costs, and ultimately higher final product costs.

In addition, low solid densities result in higher shipping costs, which trickles down to higher raw material and final product costs. This limits the distance that recycled waste streams can be shipped cost effectively, which in turn limits the capacity of the downstream manufacturing process, which again, results in another increase to the final product costs (due to economies of scale). Embodiments of the invention described herein address these problems.

Carpeting is one example of a product that usually includes a combination of different plastic materials. In particular, the carpet fibers are generally different from the materials used for backing Separating waste carpeting into the respective components is very difficult and generally not economically feasible. Additionally, post consumer carpets usually contain large amounts of dirt and other foreign materials, which increase the difficulty of recycling. Each year, large volumes of waste carpet are discarded as industrial scrap in the form of trimmings during manufacture or installation as well as post consumer carpet. Regardless of the source, most carpet materials are difficult to recycle. There has been some effort to recycle various materials that contain filaments or fibers, such as carpeting, and examples of such processes are disclosed in U.S. Patent Publication No. 2006/0147687 to Ricciardelli et al.

Plastics derived from the general waste stream, typically called Municipal Solid Waste (MSW), are also of mixed resin types, sometimes combined in a single object, and usually mixed with all of the other types of wastes normally called “garbage.” Extraction of plastics from this stream is made particularly difficult due to the presence of glass, metals, clothing and putrescible substances such as food and yard debris. Further, in spite of prohibitions, medical and toxic wastes may also be present.

Extraction of plastics from the MSW stream typically involves a combination of mechanical process and hand selection by sort line workers. In spite of these processes, residual contaminants of many types remain, and the plastics stream will typically have a substantial moisture content. Other contaminants commonly found in plastic containing waste streams, including MSW, include additives present in the plastic waste including any one or more of a cure retarder, a reinforcing agent, a filler, a densifying agent, a binder, an adhesive, a lubricant, an oxygenate, an extender, a placticizer, a vulcanization agent, an antioxidant, a fire retardant, a colorant, an electrically conductive material, and a stabilizer.

The methods and products of this invention are tolerant of these contaminants and overcome barriers to their use as feedstocks, as well as the other aforementioned problems. Additionally, the methods and products of this invention achieve other advantages discussed more fully below.

### SUMMARY OF INVENTION

In one aspect, the invention provides a method of treating waste materials by first altering a waste stream comprising plastic to produce a beneficiated plastic feedstock, and compressing the beneficiated plastic feedstock to form a compressed hydrocarbon material and forming the compressed hydrocarbon material to produce a formed hydrocarbon product.

The waste stream comprising plastic may contain acetals, acrylics, acrylonitrile-butadiene-styrene, alkyds, coumarone-indene, diallyl phthalate, epoxy, fluoropolymer, melamine-formaldehyde, nitrile resins, nylons, petroleum resins, phenolics, polyamide-imide, polyarylates, polybutylene, polycarbonate, polyethylene, polyimides, polyphenylene oxide, polyphenylene sulfide, polypropylene, polystyrene, polyurethanes, polyvinyl acetate, styrene acrylonitrile, styrene butadiene latexes, sulfone polymers, thermoplastic polyester, unsaturated polyester, urea-formaldehyde, hexachloroethane, polyethylene terephthalate, high density polyethylene, low density polyethylene, or combinations thereof.

The waste stream comprising plastic may also contain waste carpet including at least one of post-consumer carpeting, post-industrial carpet scrap, or mixtures thereof.

The waste stream is typically provided in at least one of a vertical feed hopper, a vibrating hopper, a crammer hopper, a vacuum hopper, a progressive cavity pump, a single screw extruder, a twin-screw extruder, and combinations thereof.

The altering step may include separating an inorganic component from the waste stream comprising plastic, and/or comminuting the waste stream comprising plastic, and/or shredding, crushing, or milling the waste stream comprising plastic. The altering step may also include sorting components of the waste stream comprising plastic into separate feed streams based on a physical parameter such as size, weight, volume, density, of the components of the waste stream, and/or combinations thereof. The altering step may include removing at least one organic contaminant from the waste stream comprising plastic, and/or washing, rinsing, and spraying the waste stream with water.

The compressing step may include applying a supplemental heating source to the compressing device. The method of claim 1, wherein the compressing step comprises venting gas from the beneficiated plastic feedstock being compressed.

The compressing step may be conducted on at least one of a roll press, a mechanical ram, a crammer hopper, a vacuum hopper, a progressive cavity pump, a single screw extruder, a twin screw extruder, and combinations thereof. The compressing step may include extruding the beneficiated plastic feedstock in and extruder to form a compressed hydrocarbon material. In this embodiment, the extruder may be a conical, twin-screw, counter-rotating extruder. The extruder may contain one or more heating zone(s) where external heat is applied to the plastic feedstock undergoing extrusion. The extruder may contain a die, and the die may be shape the compressed hydrocarbon material as it exits the extruder, into a cross sectional shapes such as circular, oval, square, rectangular, and trapezoidal shapes.

The methods may include adding a first additive to the beneficiated plastic feedstock prior to compressing the beneficiated plastic feedstock. The first additive may include a polyethylene, a polypropylene, a wax, a paraffin, a mineral oil, a vegetable oil, a silicone, or combinations thereof.

The methods may include adding a second additive to the beneficiated plastic feedstock, wherein the second additive such as a plastic, an inorganic compound, biomass, or a combination thereof, including compounds such as bagasse, wheat straw, corn stover, dried distiller grain solids, spent fermentation broth, saw dust, or combinations thereof.

The forming step may include chopping, cutting, pelletizing, shaving, slicing, chipping, comminuting, and/or granulating the compressed hydrocarbon material.

The forming step may be conducted with a pelletizer, a chipper, email, a knife, or combinations thereof. In certain embodiments, the forming step includes cutting the compressed hydrocarbon material exiting the extruder to obtain a formed hydrocarbon product.

The methods may also include cooling the compressed hydrocarbon material in a cooling medium comprising at least one of water and air.

The methods may also include thermally degrading the formed hydrocarbon product to form carbon-containing product such as a solid, a crude oil, and a synthesis gas. The thermal degradation may include heating the formed hydrocarbon product in the presence of diatomic oxygen, or heating the formed hydrocarbon product in the absence of diatomic oxygen.

The formed hydrocarbon product produced in these methods preferably has a higher density than the waste stream comprising plastic.

The formed hydrocarbon product produced in these methods preferably has a higher thermal conductivity than the waste stream comprising plastic.

A related aspect of the invention is a method of treating carpet waste by altering a stream of carpet waste by shredding the carpet waste and removing at least one inorganic material from the carpet waste, such as calcium carbonate, magnesium carbonate, barium sulfate, and magnesium silicate, to produce a beneficiated plastic feedstock. The beneficiated plastic feedstock is extruded in and extruder to form a compressed hydrocarbon material having a unit density between about 50 lbs/ft³ (800 kg/m³) and about 65 lbs/ft³ (1040 kg/m³); and, the compressed hydrocarbon material is shaped by cutting the compressed hydrocarbon material has it exits the extruder to produce a formed hydrocarbon product in the shape of a log.

Another aspect of the invention is a compressed hydrocarbon material comprising at least one plastic resin selected from the group consisting of polypropylene, nylon6, polyethylene, nylon 6 and nylon-6,6, polyethylene terephthalate, and polypropylene, and having a unit density between about 50 lbs/ft3 (800 kg/m3) and about 65 lbs/ft3 (1040 kg/m3). The compressed hydrocarbon material may have the shape of a log having a length of between about 10 inches and 20 inches, or the shape of a pellet.

### BRIEF DESCRIPTION OF DRAWINGS

The accompanying drawings are incorporated into and form a part of the specification to illustrate examples of how the aspects, embodiments, or configurations can be made and used and are not to be construed as limiting the aspects, embodiments, or configurations to only the illustrated and described examples. Further features and advantages will become apparent from the following, more detailed, description of the various aspects, embodiments, or configurations.

FIG. 1A shows the gasification graph for formed hydrocarbon product of the invention, formed in the shape of logs.

FIG. 1B shows the gasification graph for formed hydrocarbon product of the invention, formed in the shape of logs and cubes.

FIG. 1C shows the process gas temperature chart shows for formed hydrocarbon product of the invention, formed in the shape of cubes only.

FIG. 2 shows the results of six tests conducted using formed hydrocarbon product of the invention in the production of syncrude.

FIGS. 3A, 3B, 3C, 3D, 3E, and 3F show gasification graphs prepared using formed hydrocarbon product of the invention during each of six test runs, respectively.

### DESCRIPTION OF EMBODIMENTS

The following detailed description illustrates the invention by way of example and not by way of limitation. This description will clearly enable one skilled in the art to make and use the invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention relates to novel methods to produce valuable hydrocarbon feedstock, particularly useful in thermal degradation processes such as torrefaction, pyrolysis and gasification wherein the feedstock is converted to valuable gaseous, liquid and solid hydrocarbons products, as well as novel methods to obtain such feedstock from waste materials that include, but are not limited to, plastics. This invention also relates to combining various waste streams to produce a composite valuable hydrocarbon feedstock, wherein the waste streams may include both synthetic plastics, but also various biomass and agricultural waste streams. When describing the methods, products obtained from such methods, formulations that include such products, and methods of using such products, the following terms have the following meanings, unless otherwise indicated.

As used herein, “hydrocarbon” refers to compounds comprising hydrogen and carbon. The term also refers to compounds comprising hydrogen, carbon and oxygen, as well as compounds comprising hydrogen, carbon, oxygen and at least one other element.

As used herein, “plastic” refers to any of various organic compounds produced by polymerization, capable of being molded, extruded, cast into various shapes and films, or drawn into filaments used as textile fibers. A specified plastic can either be a thermosetting polymer or a thermoplastic polymer. Specifically, the plastic can include acetals, acrylics, acrylonitrile-butadiene-styrene, alkyds, coumarone-indene, diallyl phthalate, epoxy, fluoropolymer, melamine-formaldehyde, nitrile resins, nylon, petroleum resins, phenolics, polyamide-imide, polyarylates, polybutylene, polycarbonate, polyethylene, polyimides, polyphenylene oxide, polyphenylene sulfide, polypropylene, polystyrene, polyurethanes, polyvinyl acetate, styrene acrylonitrile, styrene butadiene latexes, sulfone polymers, thermoplastic polyester, unsaturated polyester, urea-formaldehyde, hexachloroethane, or any combination thereof. More specifically, the plastic can include polyethylene terephthalate (PET or PETE), high density polyethylene (HDPE), low density polyethylene (LDPE), polypropylene (PP), polystyrene (PS), nylon, or combinations thereof. The plastic can optionally include one or more additives.

A thermoset refers to a polymer that solidifies or “sets” irreversibly when heated. Thermosets are valued for their durability and strength and are used primarily in automobiles and construction, although applications such as adhesives, inks, and coatings are also significant. Other examples of thermoset plastics and their product applications include: polyurethanes used in mattresses, cushions, insulation, ski boots, and toys; unsaturated polyesters used in lacquers, varnishes, boat hulls, and furniture; and epoxies used in glues, and coating electrical circuits.

A thermoplastic refers to a polymer in which the molecules are held together by weak secondary bonding forces that soften when exposed to heat and return to its original condition when cooled back down to room temperature. When a thermoplastic is softened by heat, it can then be shaped by extrusion, molding or pressing. Thermoplastics offer versatility and a wide range of applications. They make up the greatest share of plastics used in food packaging because they can be rapidly and economically formed into any shape needed to fulfill the packaging function. Examples include milk jugs and soda bottles. Other examples of thermoplastics include polyethylene used in packaging, electrical insulation, milk and water bottles, packaging film, house wrap, and agricultural film; polypropylene used in carpet fibers, automotive bumpers, microwave containers, and external prostheses.

As used herein, “material comprising plastic” refers to a material (often a waste material) that comprises at least one “plastic” on a weight percent basis greater than 0 wt. %. For example, the waste material can include up to about 100 wt. % plastic, up to about 90 wt. % plastic, up to about 70 wt. % plastic, or up to about 50 wt. % plastic. The waste may include, e.g., commercial waste, industrial waste, retail waste and/or medical waste.

As used herein, “non-plastic material” refers to a material (often a waste material) that comprises at least one material other than a “plastic” on a weight basis greater than 0 wt. %. For example, the waste material can include up to about 100 wt. % non-plastic, up to about 90 wt. % non-plastic, up to about 70 wt. % non-plastic, or up to about 50 wt. % non-plastic. The waste may include, e.g., commercial waste, industrial waste, retail waste and/or medical waste.

As used herein, “inorganic material” refers to a material (often a waste material) that does not contain a carbon-hydrogen bond. For example, the inorganic material can include inorganic compounds, including, for example, alkaline metals, alkaline earth metals, transition metals, other metals, other non-metals, or salts or compounds thereof.

As used herein, an “inorganic salt” refers to a compound that does not include any carbon atoms, that is the product resulting from the reaction of an acid and a base, e.g., sodium chloride. Any suitable inorganic salt can include those disclosed, e.g., in Aldrich Catalogue of Fine Chemicals (Milwaukee, Wis.).

As used herein, “epoxy” refers to thermosetting resins that, in the uncured form, contain one or more reactive epoxide or oxirane groups. These epoxide groups serve as cross-linking points in the subsequent curing step, in which the uncured epoxy is reacted with a curing agent or hardener. Cross-linking is accomplished through the epoxide groups as well as through hydroxyl groups that may be present. Most conventional unmodified epoxy resins are produced from epichlorohydrin (chloropropylene oxide) and bisphenol A. The other types of epoxy resins are phenoxy resins, novolac resins, and cycloaliphatic resins. Epoxy resins are used as protective coatings, bonding adhesives, in building and construction, and for electrical, and many other uses.

As used herein, “nylon” refers to a generic name for a family of long-chain polyamide engineering thermoplastics, which have recurring amide groups [—CO—NH—] as an integral part of the main polymer chain. Nylons are synthesized from intermediates such as dicarboxylicacids, diamines, amino acids and lactams, and are identified by numbers denoting the number of carbon atoms in the polymer chain derived from specific constituents, those from the diamine being given first. The second number, if used, denotes the number of carbon atoms derived from a diacid. Commercial nylons are as follows: nylon 4 (polypyrrolidone)-a polymer of 2-pyrrolidone; nylon 6 (polycaprolactam)-made by the polycondensation of caprolactam; nylon 6/6-made by condensing hexamethylenediamine with adipic acid; nylon 6/10-made by condensing hexamethylenediamine with sebacic acid; nylon 6/12-made from hexamethylenediamine and a 12-carbon dibasic acid; nylon 11-produced by polycondensation of the monomer 11-amino-undecanoic acid; nylon 12-made by the polymerization of laurolactam or cyclododecalactam, with 11 methylene units between the linking —NH—CO— groups in the polymer chain. Typical applications for nylons are found in automotive parts, electrical/electronic uses, carpeting and packaging.

As used herein, “petroleum resins” refer to thermoplastic resins obtained from a variable mixture of unsaturated monomers recovered as byproduct from cracked and distilled petroleum streams. They also contain indene, which is copolymerized with a variety of other monomers including styrene, vinyl toluene, and methyl indene. Typical applications are found in adhesives, printing inks, rubber compounding, and surface coatings.

As used herein, “polyarylates” refer to engineering thermoplastic resins produced by interfacial polymerization of an aqueous solution of the disodium salt of bisphenol A with phthalic acid chlorides in methylene chloride. The major use of polyarylates is in outdoor lighting.

As used herein, “polybutylene” refers to thermoplastic resins produced via stereospecific Ziegler-Natta polymerization of butene-1 monomer. Typical applications are found in pipe and packaging film.

As used herein, “polycarbonate” refers to engineering thermoplastic resins produced by (1) phosgenation of dihydric phenols, usually bisphenol A, (2) ester exchange between diaryl carbonates and dihydric phenols, usually between diphenyl carbonate and bisphenol A and (3) interfacial polycondensation of bisphenol A and phosgene. Typical applications are found in glazing, appliances, and electrical uses.

As used herein, “polyethylene” refers to a family of thermoplastic resins obtained by polymerizing the gas ethylene. Low molecular weight polymers of ethylene are fluids used as lubricants; medium weight polymers are waxes miscible with paraffin; and the high molecular weight polymers (i.e., over 6000) are the materials used in the plastics industry. Polymers with specific gravities ranging from about 0.910 to 0.925 are called low density; those of densities from about 0.926 to 0.940 are called medium density; and those from about 0.941 to 0.965 and over are called high density. The low-density types are polymerized at very high pressures and temperatures, and the high-density types at relatively low temperatures and pressures. A relatively new type called linear low-density polyethylene is manufactured through a variety of processes: gas phase, solution, slurry, or high-pressure conversion. A high efficiency catalyst system aids in the polymerization of ethylene and allows for lower temperatures and pressures than those required in making conventional low-density polyethylene. Copolymers of ethylene with vinyl acetate, ethyl acrylate, and acrylic acid are commercially important. Major polyethylene applications can be found in carpeting, packaging, housewares, toys and communications equipment.

Polyethylene is a waxy, translucent, somewhat flexible thermoplastic, prepared by polymerizing ethylene at high pressure (1,000 to 4,000 atm) and high temperature in the presence of a trace of oxygen. Polyethylene is insoluble in all solvents and is resistant to the action of most reagents, other than strong oxidizing acids. Above 115° C., the polymer changes from a clear solid to a relatively low-viscosity melt. At this temperature and above, exposure to air causes relatively extensive oxidative degradation, unless antioxidants are included with the polymer.

Polyethylene is widely used as a film by itself or as a hot extrusion onto paper to provide additional strength and moisture-resistant characteristics. It is also applied to printing papers to provide finish and strength. The material is also made in sheets for use as a facing to prevent materials from sticking to a surface in operations requiring the application of pressure. The film, which does not adhere permanently to waxes and many plastics in the unhardened state, is easily peeled off when the operation is completed. In sheet form, it is used in conservation work, in lieu of cellulose acetate lamination, to protect brittle paper, in which case the paper is placed between two sheets of the film, which is then sealed with double-sided adhesive tape around the edges. It may also be sealed by means of plastic welding.

Low molecular weight polymers of ethylene are fluids used as lubricants; medium weight polymers are waxes miscible with paraffin; and high molecular weight polymers (e.g., over 6000) are the materials used in the plastics industry. A relatively new type called linear low-density polyethylene (LLDPE) is manufactured through a variety of processes: gas phase, solution, slurry, or high-pressure conversion. A high efficiency catalyst system aids in the polymerization of ethylene and allows for lower temperatures and pressures than those required in making conventional low-density polyethylene. Copolymers of ethylene with vinyl acetate, ethyl acrylate, and acrylic acid are commercially important.

As used herein, “polyimides” refer to a family of thermoset and thermoplastic resins characterized by repeating imide linkages. There are four types of aromatic polyimides: (1) condensation products made by the reaction pyromellitic dianhydride (PMDA) and aromatic diamines such as 4,4′-diaminodiphenyl ether; (2) condensation products of 3,4,3′,4′-benzophenone tetracarboxylic dianhydride (BTDA) and aromatic amines; (3) the reaction of BTDA and a diisocyanate such as 4,4′-methylene-bis(phenylisocyanate); and (4) a polyimide based on diaminophenylindane and a dicarboxylic anhydride such as carbonyldiphthalic anhydride. Thermoset polyimides are produced in condensation polymers that possess reactive terminal groups capable of subsequent cross-linking through an addition reaction. Typical applications for thermoplastic and thermosetting polyimides are transportation and electronics.

As used herein, “polypropylene” refers to thermoplastic resins made by polymerizing propylene and in the case of copolymers with monomers, with suitable catalysts, generally aluminum alkyl and titanium tetrachloride mixed with solvents. The monomer unit in polypropylene is asymmetric and can assume two regular geometric arrangements: isotactic, with all methyl groups aligned on the same side of the chain, or syndiotactic, with the methyl groups alternating. All other forms, where this positioning is random, are called atactic. Commercial polypropylene contains 90-97% crystalline or isotactic PP with the remainder being atactic. Most processes remove excess atactic PP. This by-product is used in adhesives, caulks, and cablefilling compounds. Major applications of commercial PP are found in packaging, automotive, appliance and carpeting markets.

As used herein, “polystyrene” refers to high molecular weight thermoplastic resins produced generally by the free-radical polymerization of styrene monomer which can be initiated by heating alone but more effectively by heating in the presence of free-radical initiator (such as benzoyl peroxide. Typical processing techniques are modified mass polymerization or solution polymerization, suspension polymerization, and expandable beads. Major markets for polystyrene are in consumer and institutional products, electrical/electronic uses, and building/construction.

As used herein, “polyurethanes” refer to a large family of polymers based on the reaction product of an organic isocyanate with compounds containing a hydroxyl group.

The commonly used isocyanates are toluene diisocyanate (TDI), methylene diphenyl isocyanate (MDI), and polymeric isocyanates (PMDI), obtained by the phosgenation of polyamines derived from the condensation of aniline with formaldehyde [HCHO]. Polyols (with hydroxyl groups) are macroglycols, which are either polyester or polyether based. Polyurethane elastomers and resins take the form of liquid castings systems thermoplastic elastomers and resins, microcellular products, and millible gums. Typical applications are found in the automotive industry. Polyurethane foams are widely used in transportation, furniture, and construction markets.

As used herein, “polyvinyl acetate” (PVAc) refers to a thermoplastic resin produced by the polymerization of vinyl acetate monomer in water producing an emulsion with a solids content of about 50-55%. Most polyvinyl acetate emulsions contain co-monomers such as n-butyl acrylate, 2-ethyl hexyl acrylate, ethylene, dibutyl maleate and dibutyl fumarate. Polymerization of vinyl acetate with ethylene also can be used to produce solid vinyl acetate/ethylene copolymers with more than 50% vinyl acetate content. Polyvinyl alcohol (PVOH) is produced by methanolysis or hydrolysis of polyvinyl acetates. The reaction can be controlled to produce any degree of replacement of acetate groups. Co-polymers of replaced acetate groupings and other monomers such as ethylene and acrylate esters are commercially important. Polyvinyl butyral (PVB) is made by reacting PVOH with butyraldehyde. Polyvinyl formal is made by condensing formaldehyde [HCHO] in presence of PVOH or by the simultaneous hydrolysis and acetylization of PVAc. Polyvinylidene chloride is made by the polymerization of 1,1-dichloroethylene. Typical applications for the above resins are found in adhesives, paints, coatings and finishes, and packaging.

As used herein, “thermoplastic polyester” refers to a family of polyesters in which the polyester backbones are saturated and hence unreactive. The most common commercial types include: PET (polyethylene terephthalate) produced by polycondensation of ethylene glycol with either dimethyl terephthalate (DMT) or terephthalic acid (TPA); and PBT (polybutylene terephthalate) produced by the reaction of DMT with 1,4 butanediol. Typical applications are found in packaging, automotive, electrical, and consumer markets.

As used herein, “unsaturated polyester” refers to thermosetting resins made by the condensation reaction between difunctional acids and glycols. The resulting polymer is then dissolved in styrene or other vinyl unsaturated monomer. The structures of the acids and glycols used and their proportions, especially the ratio of the unsaturated versus the saturated acid, and the type and amount of monomer used, are all tailored for each resin to balance economy, processing characteristics, and performance properties. One common formulation is the reaction of maleic anhydride, phthalic anhydride, and propylene glycol. Both dicyclopentadiene and isophthalic acid can be substituted for phthalic anhydride. Vinyl ester resins are linear reaction products of bisphenol A and epichlorohydrin that are terminated with an unsaturated acid such as methacrylic acid. Typical applications are found in transportation, appliances, electrical, and construction markets.

As used herein, a “polymeric adhesion modifier” or “bonding polymer” refers to a material to help bond together polymers used in toughened, filled, and blended compounds. Suitable classes of polymeric adhesion modifiers include, e.g., anhydride grafted polyolefin resins, styrene maleic anhydride (SMA) copolymers, and combinations thereof. Specifically, the anhydride can be maleic anhydride. Specifically, the polyolefin can be polyethylene, polypropylene, EPDM, ethylene vinyl acetate (EVA), a copolymer thereof, or a combination thereof.

As used herein, “bulk density” refers to the measurement of a material in terms of mass per unit volume where this measurement includes empty pore volume in the material as well as interstitial spaces. Thus, “bulk density” is less than or equal to “unit density” which as used herein, does not include the affect of pore volume or interstitial spaces. Typical units of measurement for “bulk density” and “unit density” include lb/ft³, lb/gal and kg/m³.

As used herein, “specific gravity” refers to the ratio of a material's bulk density to the bulk density of a reference material, this reference material, as used herein, being water at normal conditions.

As used herein, “thermal conductivity” refers to the rate of heat transfer through or across a material. Typical units of measure for thermal conductivity are BTU/hr*ft*F and W/m*K.

As used herein, “specific thermal conductivity” refers to the ratio of a material's thermal conductivity to the thermal conductivity of a reference material, this reference material, as used herein, being water at normal conditions. Normal conditions are defined as 0° C. and 14.7 psia. The bulk density of water at normal conditions is 62.4 lb/ft³. The thermal conductivity of water at normal conditions is 0.336 BTU/hr*ft*F.

As used herein, “biomass” is biological material derived from living things and includes, but is not limited to, starch, corn syrup, cornsteep liquor, black liquor, fermentation broth, dried distiller grain solids, bagasse, corn stover, wheat straw, wood chips, saw dust, miscanthus, switchgrass, hemp, poplar, willow, sorghum, bamboo, any materials comprising at least one of cellulose, hemicelluloses, lignin, lipids, oils and proteins, and any combination thereof.

As used herein, the term “filler” refers to any material added to another material to help improve the second material's physical properties. A “densifying agent” is an example of a specific “filler” that is intended to raise or increase the density of the material that the densifying agent is being added to. A “plasticizer” is another example of a filler that is added to a material to change the rheological properties of the second material, including but not limited to, increasing the fluidity and decreasing the viscosity of the first material. Further examples of fillers include, but are not limited to, “binders” and “adhesives” which are added to create a mixture of components with higher structural strength and integrity, “lubricants” which are added to lower frictional heat losses, and “oxygenates” which provide an additional source of oxygen. Examples of organic “fillers” are known to one of ordinary skill in the art and are not listed herein.

An aspect of the invention provides a method of treating waste materials that includes altering a waste stream comprising plastic to produce a beneficiated plastic feedstock. The beneficiated plastic feedstock created by the altering step is compressed to form a compressed hydrocarbon material. The compressed hydrocarbon material is formed to produce a formed hydrocarbon product.

The formed hydrocarbon product preferably has a higher density than the starting waste stream comprising plastic. This higher density enables more efficient down-stream processing of the hydrocarbon products, for example in thermal degradation processes used to produce crude oils, synthesis gas, solids and other valuable carbon-containing products and intermediates.

The formed hydrocarbon product preferably has a higher thermal conductivity than the starting waste stream comprising plastic. Similarly, higher thermal conductivity enables more efficient down-stream processing of the hydrocarbon products, for example in thermal degradation processes used to produce crude oils, synthesis gas, solids and other valuable carbon-containing products and intermediates.

The waste stream comprising plastic may contain at least one plastic selected from the group consisting of acetals, acrylics, acrylonitrile-butadiene-styrene, alkyds, coumarone-indene, diallyl phthalate, epoxy, fluoropolymer, melamine-formaldehyde, nitrile resins, nylons, petroleum resins, phenolics, polyamide-imide, polyarylates, polybutylene, polycarbonate, polyethylene, polyimides, polyphenylene oxide, polyphenylene sulfide, polypropylene, polystyrene, polyurethanes, polyvinyl acetate, styrene acrylonitrile, styrene butadiene latexes, sulfone polymers, thermoplastic polyester, unsaturated polyester, urea-formaldehyde, hexachloroethane, polyethylene terephthalate, high density polyethylene, and low density polyethylene.

In a related embodiment, the waste stream comprising plastic may contain at least one of municipal solid waste, container waste, packaging waste, electronic waste, durable goods waste, non-durable goods waste, building and construction waste, and combinations thereof.

In one embodiment, the waste stream comprising plastic contains waste carpet. The waste carpet is altered to produce a beneficiated plastic feedstock that is compressed, resulting in a compressed hydrocarbon material, which may be formed to produce a formed hydrocarbon product. The formed hydrocarbon material has a higher density and/or thermal conductivity than the starting waste carpet, enabling more efficient down-stream processing, for example in thermal degradation processes, to produce to crude oils, synthesis gas, solids and other valuable carbon containing products and intermediates.

The waste carpet may contain a plastic selected from the group consisting of acetals, acrylics, acrylonitrile-butadiene-styrene, alkyds, coumarone-indene, diallyl phthalate, epoxy, fluoropolymer, melamine-formaldehyde, nitrile resins, nylons, petroleum resins, phenolics, polyamide-imide, polyarylates, polybutylene, polycarbonate, polyethylene, polyimides, polyphenylene oxide, polyphenylene sulfide, polypropylene, polystyrene, polyurethanes, polyvinyl acetate, styrene acrylonitrile, styrene butadiene latexes, sulfone polymers, thermoplastic polyester, unsaturated polyester, urea-formaldehyde, hexachloroethane, polyethylene terephthalate, high density polyethylene, low density polyethylene, and combinations thereof.

In one embodiment, the waste carpet is post-consumer carpeting, or post-industrial carpet scrap, or mixtures thereof. This waste carpet may comprise a face fiber component and a backing material, which includes a woven or non-woven backing component and a binder material typically comprising thermoset or thermoplastic binding materials.

The face fiber component of waste carpet may be a material comprising plastic having a fiber component formed of various plastic materials. Backing or binding materials of the waste carpet may contain a primary plastic component, such as, but not limited to, polypropylene. The backing material may contain about 30% to about 50% by weight of plastic material based on the weight of the backing.

The face fiber component of waste carpet can include a combination of components, which are made from various plastics including, for example, nylons, polyethylene terephthalate, acrylonitrile-butadiene-styrene copolymers, polypropylenes, unsaturated and saturated polyesters and polyurethanes. Waste carpet fiber can be woven or non-woven materials. Non-woven carpets, comprising carpet fibers, are typically bonded with a suitable binding material. Non-woven carpets can be fiber mats where the fibers are bonded together by the bonding properties of the fibers or by a plastic binding material. More commonly, non-woven carpets are tufted carpets whereby the face fibers are punched into a woven substrate typically polypropylene, but could be other materials.

Carpets can be woven or tufted. The bulk of manufactured carpeting is tufted carpet, whose face components can be cut pile, loop pile, combinations of cut and loop, or shag-type carpets. Tufted carpet scrap typically originates from what is known as Broadloom carpet. The carpet typically includes twisted yarns or rovings of natural or synthetic filaments that are needled through a base or backing fabric. The backing fabric can be, for example, a woven or non-woven material and generally includes a binding agent or a back coating. Commonly, used back coatings include various glues or binders such as ethylene vinyl acetate copolymers and styrene butadiene copolymers. The back coating generally contains inorganic fillers such as calcium carbonate, magnesium carbonate, barium sulfate, magnesium silicate, such as talc, and mixtures thereof.

The waste carpet fibers may be made of plastic materials having a melting point of about 190° C. or higher. One embodiment of the invention includes the use of a waste stream comprising waste carpet having a face fiber component, a thermoplastic backing component as well as thermoset or thermoplastic binder component. The fiber ratios of the post-manufacture waste are approximately: 65% polypropylene (PP), 20% nylons, 15% polyethylene terephthalate (PET). The waste carpet preferably includes carpet fibers having a length of about ⅛ inch to about 2 inches. The carpet fibers are provided in the form of yarns or rovings made from filaments or fibers used in the manufacture of carpets.

The fibers in certain carpet wastes are thermoplastic polymers. Examples of preferred plastic fiber materials include polyamides, such as nylon-6 and nylon-6,6, polyesters, such as polyethylene terephthalate, and polypropylenes. In further embodiments, the fiber component can be a naturally occurring fiber, such as wool or cotton, or other fibrous materials and other inorganic fibers.

In certain embodiments, the waste stream comprising plastic, of which waste carpet is one example, is characterized by a specific gravity of less than about 0.3. In another embodiment the waste stream is characterized by a specific gravity of less than about 0.2. In another embodiment the waste stream is characterized by a specific gravity of less than about 0.1.

In certain embodiments, the waste stream comprising plastic, of which waste carpet is one example, is characterized by a specific thermal conductivity of less than about 0.03 BTU/hr*ft*F. In other embodiments, the waste stream comprising plastic is characterized by a specific thermal conductivity between about 0.03 BTU/hr*ft*F and about 0.12 BTU/hr*ft*F. In other embodiments, the waste stream comprising plastic is characterized by a specific thermal conductivity between about 0.06 BTU/hr*ft*F and about 0.12 BTU/hr*ft*F. In other embodiments, the waste stream comprising plastic is characterized by a specific thermal conductivity between about 0.03 BTU/hr*ft*F and about 0.06 BTU/hr*ft*F. In other embodiments, the waste stream comprising plastic is characterized by a specific thermal conductivity of less than about 0.12 BTU/hr*ft*F.

In these embodiments, the waste stream comprising plastic may be received in various physical forms (e.g. bails, logs, loose form). Suitable means for receiving these waste materials to create a waste stream comprising plastic for altering and delivery to the downstream process steps include, but are not limited to, a vertical feed hopper, a vibrating hopper, a crammer hopper, a vacuum hopper, a progressive cavity pump, a single screw extruder, a twin-screw extruder, or combinations thereof.

The waste stream comprising plastic stream is altered to beneficiate the waste stream in order that it may be better compressed or formed in subsequent steps. For example, in the case of a waste stream comprising waste carpet, altering the waste carpet to remove inorganic fillers and/or backing materials enhances the subsequent compressing and forming steps to produce a better informed hydrocarbon product. Waste carpet generally contains only about 10% to about 50% by weight of plastic fibers based on the total weight of the carpet. In specific embodiments, the waste carpet contains at least about 20% by weight of plastic fibers. The remainder of the waste carpet includes, but is not limited to, inorganic fillers and backing materials. Examples of typical inorganic fillers include calcium carbonate, magnesium carbonate, magnesium silicate and barium sulfate. The backing material of carpet generally contains about 50-80% by weight of other components, such as, inorganic fillers and latex materials, where the percentages are based on the weight of the backing In specific embodiments, the weight fractions of the raw carpet waste, both post-manufacture and post-consumer, are about 40-50% by weight calcium carbonate, with the remainder comprising polypropylene, nylon, and PET. In one embodiment, this waste carpet comprises about 40-50% by weight calcium carbonate that is altered to produce a beneficiated waste carpet stream of about 3% by weight, or less, calcium carbonate.

For waste streams comprising plastic, including those containing waste carpet, the altering step can include separating inorganic components from the waste stream comprising plastic prior to compressing. In the case of waste carpet, the altering step can include separating inorganic components of the waste carpet from the carpet fibers. This separating can be accomplished by physical means, chemical means, or both. In one embodiment, the separating is by processing in a series of cleaning sequences, via step cleaners or other cleaning procedures. Alternatively, certain inorganic materials may be removed as solids by physical separation means such as cyclone air separators.

In some embodiments, the waste stream comprising plastic may be altered by comminuting to reduce the particle size of the waste carpet. Specifically, a waste stream comprising plastic can be reduced in size by shredding, cutting, slicing, ripping, shaving, tearing, slashing, carving, cleaving, crushing, cutting, dissevering, hacking, incising, severing, shearing, fragmenting, fraying, lacerating, and/or grinding. Specifically, the waste stream comprising a plastic can be reduced in size, such that the average size of the resulting plastic fragments are less than about 100% of the size of the plastic pieces in the waste stream comprising plastic. Specifically, the waste stream comprising a plastic can be reduced in size, such that the average size of the resulting plastic fragments are less than about 50% of the size of the plastic pieces in the waste stream comprising plastic. Specifically, the waste stream comprising a plastic can be reduced in size, such that the average size of the resulting plastic fragments are less than about 25% of the size of the plastic pieces in the waste stream comprising plastic. Specifically, the waste stream comprising a plastic can be reduced in size, such that the average size of the resulting plastic fragments are less than about 10% of the size of the plastic pieces in the waste stream comprising plastic.

Altering the waste stream comprising plastic to reduce the particle size may occur in a single piece of equipment, or in two or more pieces of equipment.

In a specific embodiment, waste carpet is altered by reducing the waste carpet pieces in size by at least one of shredding, crushing and milling, which may include hammer milling or ball milling. In the case of carpet waste, hammer milling creates small fiber sizes, making it difficult to separate the fibers from inorganic materials, such as carbonates, thereby reducing fiber recovery to about 50%. A shredder results in longer fibers, with the inorganics stripped off, and therefore a more efficient separation of carpet fibers from the contaminants when air driven step cleaners are used. In other embodiments, the means of separating the inorganic components from waste carpet fiber is a shredder, such as the “cat's claw” shredder (Southern Mechatronics). This device eliminates approximately 97% of the waste carpet's inorganic components, while retaining almost all of the plastic fiber (approximately 98%). In other embodiments, the means of separating the inorganic components from the plastic carpet fiber is a water cyclone separator such as the Tornado Pulper (Environmental Recycled Carpet Systems). In this equipment, water is used to soften the inorganic component, e.g. calcium carbonate, which then crumbles away from the carpet backing resulting in easier physical separation of the plastic fiber from the inorganic. The device eliminates approximately 98% of the inorganic and retains almost all of the fiber (approximately 99%).

In an embodiment the altering step may include a chemical separating means, such as treating a waste carpet stream with solvent to dissolve the inorganic material, after which the inorganic material is removed by removing the solvent in which it is dissolved.

In some embodiments, the altering of the waste stream comprising waste carpet can include removing at least about 10 wt. % of the inorganic material from the waste carpet. More specifically, at least about 50 wt. % of the inorganic material can be removed from the waste carpet. More specifically, at least about 75 wt. % of the inorganic material can be removed from the waste carpet. More specifically, up to about 100 wt. % of the inorganic material can be removed from the waste carpet.

In some embodiments, at least about 10 wt. % of an inorganic salt can be removed from the waste carpet. More specifically, at least about 50 wt. % of an inorganic salt can be removed from the waste carpet. More specifically, at least about 75 wt. % of an inorganic salt can be removed from the waste carpet. More specifically, up to about 100 wt. % of an inorganic salt can be removed from the waste carpet.

Specifically, at least about 10 wt. % of an inorganic material selected from the group consisting of calcium carbonate, magnesium carbonate, barium sulfate, magnesium silicate, such as talc, and mixtures thereof, present in waste carpet can be removed from the waste carpet. More specifically, at least about 50 wt. % of an inorganic material selected from the group consisting of calcium carbonate, magnesium carbonate, barium sulfate, magnesium silicate, and mixtures thereof, can be removed from the waste carpet. More specifically, at least about 75 wt. % of an inorganic material selected from the group consisting of calcium carbonate, magnesium carbonate, barium sulfate, magnesium silicate, and mixtures thereof, can be removed from the waste carpet. More specifically, up to about 100 wt. % of an inorganic material selected from the group consisting of calcium carbonate, magnesium carbonate, barium sulfate, magnesium silicate, and mixtures thereof, can be removed from the waste carpet.

Altering the waste stream comprising plastic may include sorting the components of the waste stream based on physical parameters such as size, weight, volume, density, or a combination thereof. For example, the waste stream comprising plastic can be sorted to provide a relatively dense plastic feedstock and a relatively non-dense plastic feedstock. Alternatively, the waste stream comprising plastic can be sorted to provide relatively large plastic feedstock separated from relatively small plastic feedstock.

In some embodiments of the invention, the altering step may include the removal of at least some organic contaminants from the waste stream comprising plastic. The organic contaminants removed may be discarded or employed for other purposes. In some embodiments, the organic contaminants are metal and can be separated or removed by exposing the waste stream comprising plastic to a magnetic field, to remove at least a portion of the metal contaminants located therein. For example, a shredder may include a magnetic metal excluder on the in-feed section. For those metal contaminants that are not magnetically charged, such metal contaminants can be removed via centripetal or centrifugal forces. Such metal contaminants will typically have densities that vary significantly from the densities of the other components typically present in the material comprising plastic, such as waste carpet.

In other embodiments, at least some of the organic contaminants can be separated or removed from the waste stream comprising plastic by washing, rinsing or spraying with a composition that includes water. Such a composition can optionally include at least one of a detergent, a surfactant, a de-surfactant, a cationic agent, an anionic agent and a non-ionic agent.

Specifically, the organic contaminant(s) can include household contaminants, agricultural contaminants, and/or industrial contaminants. More specifically, the organic contaminant(s) can include food residue, drink residue, paper, animal soiling, human soiling, blood, tissue, effluence, waste vegetable contamination, cleaning fluids, household chemicals, silage, grass, general vegetation residue, animal slurry, fertilizer, chemicals, crossed link polymers, lubricants, foaming agents, blowing agents, organics, inorganics, surfactants, plastic adhesion modifiers, bonding polymers, free radical sources, cross-linking agents, decomposition accelerating agents, cure retarders, reinforcing agents, fillers, extenders, plasticizers, vulcanization agents, antioxidants, fire retardants, colorants, electrically conductive materials, and/or stabilizers.

As stated above, at least some of the organic contaminant(s) located therein can be removed in the altering step. Specifically, at least about 10 wt. % of the contaminants located therein can be removed. More specifically, at least about 50 wt. % of the contaminants located therein can be removed. More specifically, at least about 75 wt. % of the contaminants located therein can be removed. More specifically, up to about 100 wt. % of the contaminants located therein can be removed.

In some embodiments, the altering step may produce a saleable byproduct stream comprising inorganic or organic contaminants removed from the waste stream comprising plastic. This byproduct stream includes, but is not limited to, metals and carbonates.

The beneficiated plastic feedstock is compressed, resulting in a compressed hydrocarbon material. Compressing the beneficiated hydrocarbon material results in a compressed hydrocarbon material with a specific gravity and/or a specific thermal conductivity higher than that of the waste stream comprising plastic. Compressing can be accomplished by physical compression using equipment including, but not limited to, a roll press, a mechanical ram, a crammer hopper, a vacuum hopper, a progressive cavity pump, a single screw extruder, a twin-screw extruder, or combinations thereof. Compressing removes gas voids from the beneficiated plastic material. As a result of compressing, a compressed hydrocarbon material is produced wherein the compressed hydrocarbon material is characterized by specific gravity of greater than about 0.3. In another embodiment the compressed hydrocarbon material is characterized by specific gravity of greater than about 0.4. In another embodiment the compressed hydrocarbon material is characterized by specific gravity of greater than about 0.5, 0.6, 0.7, 0.8, 0.9 or 1.0. In another embodiment the compressed hydrocarbon material is characterized by a specific gravity between about 0.4 and about 1.0. In another embodiment the compressed hydrocarbon material is characterized by a specific gravity between about 0.8 and about 1.0.

In an embodiment the compressed hydrocarbon material is characterized by specific thermal conductivity of greater than about 0.030. In another embodiment the compressed hydrocarbon material is characterized by specific thermal conductivity of greater than about 0.035. In another embodiment the compressed hydrocarbon material is characterized by specific thermal conductivity of greater than about 0.040, 0.045, 0.050, 0.055, or 0.060. In another embodiment the compressed hydrocarbon material is characterized by a thermal conductivity between about 0.030 and about 0.060. In another embodiment the compressed hydrocarbon material is characterized by a thermal conductivity between about 0.045 and about 0.055.

Compression generally results in frictional heat. Therefore, compression is normally accompanied with at least some natural heating of the material being compressed. This natural heating may be supplemented with additional heat input into the compressing device using, for example, electrical heaters or hot circulating fluids. Heating results in a temperature rise in the beneficiated hydrocarbon material. When this temperature rise exceeds the average melting temperature of the beneficiated hydrocarbon material, liquid is formed which may then fill interstitial voids and other air-filled voids, thus increasing the beneficiated hydrocarbon material's specific gravity and/or thermal conductivity.

The compressing may also result in the formation or release of gas. Therefore, an embodiment of this invention includes a means for venting gas from the material being compressed. Examples include a simple vent pipe to atmosphere or a vent pipe to a vacuum pump. In any case, the vent may also be supplemented with a condenser to trap condensable components. Venting entrapped gas and gas formed during compressing promotes a higher specific gravity and thermal conductivity in the final compressed hydrocarbon material.

In specific embodiments, the compressing may be by any acceptable extrusion means. This includes a single screw extruder or twin-screw extruder, including either co-rotating or counter-rotating twin-screw extruders. The extruder barrel may be conical or cylindrical. The extruder barrel may also be conventional or grooved. A grooved barrel may be used to maximize frictional heat generation, and to minimize the amount of supplemental heat required to obtain the desired extruder temperatures. In some embodiments, the average screw diameter may be greater than 0.5, 1.0, 1.5, 2, 3, 4, 5, 6, 7, 8, 9, 10 or 12 inches. In some embodiments, the screws may be non-coated or coated. The coatings may include PTFE impregnated nickel/chrome plating, titanion-nitride, boron-nitride, or tungsten-disulfide coatings.

In these embodiments, the beneficiated hydrocarbon material may be fed at a rate equal to the extruder flood feed rate, or at a rate less than the extruder flood feed rate.

The extruder may be high-speed, moderate speed, or low-speed. In some embodiments, the extruder comprises at least one feed zone. In other embodiments, the extruder comprises more than one feed zone. In specific embodiments, the compressing is with a conical, twin-screw, counter-rotating extruder.

The extruder may also comprise one or more heating zone(s) wherein external heat is applied to the beneficiated plastic feedstock undergoing extrusion. In an embodiment, the extruder comprises at least one heating zone wherein the temperature of the beneficiated plastic feedstock is elevated to a temperature that is greater than about 150° C., 175° C., 200° C., 225° C., 250° C., 275° C. or about 300° C. In another embodiment the extruder comprises at least one heating zone wherein the temperature of the beneficiated feedstock is greater than about 150° C. and at least one heating zone wherein the temperature of the beneficiated feedstock is less than about 150° C. in another embodiment the extruder comprises at least one heating zone wherein the temperature of the beneficiated feedstock is greater than about 300° C. and at least one heating zone wherein the temperature of the beneficiated feedstock is less than about 300° C. in another embodiment the extruder comprises at least one heating zone wherein the temperature of the beneficiated feedstock is between about 150° C. and about 300° C.

In some embodiments, the extruder screw and barrel lengths may be as long as required to achieve the desired number of heating and compressing zones. In an embodiment, the extruder screw and barrel lengths may be greater than 1 foot, 2, 3, 4, 5, 6, 7, 8, 9, 10, 20 or 30 feet. In an embodiment, the extruder screw and barrel lengths are between about 1 foot and about 30 feet in length.

In some embodiments, the extruder screw speed (“speed” being synonymous with “rate”) may be greater than 1 rpm, 5, 10, 15, 20, 30, 40, 50, 80 or 100 rpm. In an embodiment, the screw speed is between about 5 rpm to about 12 rpm. In another embodiment, the screw speed is between about 8 rpm to about 10 rpm.

In some embodiments, the extruder may also comprise a die, wherein the die and screw speed together control the pressure in the extruder just before the beneficiated hydrocarbon feedstock exits the extruder as a compressed hydrocarbon material. In an embodiment, the exit pressure of the extruder is greater than 100 psig, 200 psig, 300 psig, 400 psig, 500 psig, 600 psig, 700 psig, 800 psig, 900 psig, or 1000 psig. In an embodiment, the exit pressure of the extruder is between about 100 psig and about 1000 psig. In another embodiment, the exit pressure of the extruder is between about 300 psig and about 700 psig.

In some embodiments, the die shapes the compressed hydrocarbon material as it exits the extruder. This shape includes, but is not limited to, logs or strands, these being circular, oval, square, rectangular, or trapezoidal in cross-section, or any other reasonable two-dimensional die shape commonly available in the extrusion field. The die may also comprise more than one exit with the multiple exits having the same or different cross-sectional shapes.

In some embodiments, the average diameter of the at least one die may be greater than 0.25 inches, 1.0 inches, 2 inches, 4 inches, 6 inches, 8 inches, 10 inches, or 12 inches. In another embodiment, the average diameter of the at least one die may be is between about 0.5 inches and about 12 inches.

In these embodiments, multiple extruders may be used in series or in parallel.

In one embodiment, the beneficiated plastic feedstock is an altered carpet scrap that is extruded to form a compressed hydrocarbon material having a unit density of at least about 16 lbs/ft³ (256 kg/m³). Specifically, the compressed hydrocarbon material has a unit density of at least about 20 lbs/ft³ (320 kg/m³). Specifically, the compressed hydrocarbon material has a unit density of at least about 50 lbs/ft³ (800 kg/m³). Specifically, the compressed hydrocarbon material has a unit density of between about 50 lbs/ft³ (800 kg/m³) and about 65 lbs/ft³ (1040 kg/m³). Specifically, the compressed hydrocarbon material has a unit density of about 62 lbs/ft³ (993 kg/m³). Specifically, the compressed hydrocarbon material has a unit density of greater than about 70 lbs/ft³ (1120 kg/m³).

In these embodiments, a first additive may be added either before the compressing step, or during the compressing step. In one embodiment, a first additive is added to the plastic-containing feedstock prior to the compressing step. In an embodiment, a first additive is added to the first feed zone of the extruder with the beneficiated hydrocarbon feedstock. In a related embodiment, a first additive is added to a second feed zone of the extruder, downstream of the feed zone for adding the beneficiated hydrocarbon feedstock to the extruder. In an embodiment, the first additive is added during the altering step. In some embodiments, the first additive is a lubricant consisting of at least one of a low molecular weight polyethylene, a low molecular weight polypropylene, a wax, a paraffin, a mineral oil, a vegetable oil, a silicone, or combinations thereof. In a specific embodiment, the lubricant is Strucktol TPW 104.

In one embodiment, the lubricant is Strucktol TPW 104, wherein the Strucktol TPW 104 is added with the beneficiated feedstock at the extruder's first feed zone, at a weight fraction of greater than 1 wt. % relative to the weight of beneficiated feedstock being fed to the first feed zone. In an embodiment, the weight fraction of Strucktol TPW 104 added is between about 2 wt. %, and about 10 wt. %.

In some embodiments, a second additive is added to the beneficiated plastic feedstock, the compressed hydrocarbon material, with the formed hydrocarbon product. A second additive may include, but is not limited to, at least one filler, for example plasticizer, lubricant, oxygenate, or any combination thereof. A second additive may comprise a plastic, an inorganic compound, biomass, or combination thereof. In some embodiments, a second additive comprises a plastic. In some embodiments, a second additive comprises polypropylene. In some embodiments, a second additive comprises biomass wherein the biomass comprises cellulose, lignin, hemicellulose, a lipid, a protein, or combinations thereof. In some embodiments, a second additive comprises biomass waste comprising at least one of bagasse, wheat straw, corn stover, dried distiller grain solids, spent fermentation broth, saw dust, or combinations thereof.

In these embodiments, the compressed hydrocarbon material may be shaped in a forming step. The forming step may comprise at least one of chopping, cutting, pelletizing, shaving, slicing, chipping, comminuting, granulating or a combination thereof, of the compressed hydrocarbon feed stock. The forming step may be done at the same site or location as the compressing, or the forming may be done at a different location, such as a location where the compressed hydrocarbon material is used to produce a carbon-containing product, for example, crude oil, synthesis gas, solid or other valuable carbon-containing product or intermediate. Forming may be accomplished using any suitable equipment including, but not limited to, a pelletizer, a chipper, a mill, a knife, or combinations thereof. The forming step may include, but is not limited to, a ball mill, hammer mill or knife mill. The forming step may include cutting the compressed hydrocarbon material exiting and extruder to obtain a formed hydrocarbon having a shape and size dictated by the extruded shape and the length between cuts applied to the compressed hydrocarbon material. One embodiment, the shape may be a block. In another embodiment, the shape may be a log.

In some embodiments, the compressed hydrocarbon material is cooled prior to forming or after forming. In some embodiments, the cooling step is by convective and/or conductive heat transfer from the compressed hydrocarbon material to a cooling medium, wherein the cooling medium may be, but is not limited to, water or air. In another embodiment, cooling is achieved by a water cooling trough. In another embodiment, cooling is achieved using convective air flow, for example from cooling fans.

In an embodiment, at least one of the waste stream comprising a plastic, and the beneficiated plastic feedstock is dried prior to the compressing. In another embodiment, the beneficiated hydrocarbon feedstock is dried during compressing in an extruder in a drying zone, wherein the drying zone comprises a vent.

In some embodiments, one or both of the compressed hydrocarbon material and the formed hydrocarbon product are reacted to form at least one solid, crude oil, synthesis gas or other valuable carbon-containing product and intermediate. This reacting step may be a thermal degradation step, wherein the thermal degradation step comprises torrefaction, pyrolysis or gasification.

In an embodiment, the thermal degradation step comprises heating a hydrocarbon feedstock to above 200° C. (390° F.) in the absence of air or diatomic oxygen. In another embodiment, the thermal degradation step comprises heating a hydrocarbon feedstock to above 800° C. in the absence of air or diatomic oxygen. In another embodiment, the thermal degradation step comprises heating a hydrocarbon feedstock to a temperature between about 200° C. and about 800° C. in the absence of air or diatomic oxygen.

In an embodiment, the thermal degradation step comprises heating a hydrocarbon feedstock in the presence of diatomic oxygen, wherein the stoichiometric amount of oxygen added is less than the stoichiometric amount of oxygen needed to completely combust the hydrocarbon feedstock to carbon dioxide and water.

In an embodiment, the thermal degradation step comprises heating a hydrocarbon feedstock in the absence of diatomic oxygen and in the presence of steam.

In another embodiment, the thermal degradation step comprises heating a hydrocarbon feedstock in the presence of diatomic oxygen and in the presence of steam.

As stated above, each of the altering, compressing and forming steps may be employed in the process of the present invention. As such, in a preferred embodiment of the methods of the present invention, the methods can be carried out with the inclusion of any combination of the specific receiving, altering, separating, compressing, heating, cooling, forming, drying, analyzing, and reacting steps described above, so long as the altering and compressing and forming steps are performed.

For example, the methods of the present invention can include both reducing of the particle size and contaminant removal from the waste stream comprising plastic. In one embodiment, reducing of the particle size and contaminant removal can occur prior to removing at least a portion of an inorganic component. In another embodiment, reducing of the particle size and contaminant removal can occur subsequent to removing at least a portion of an inorganic component.

In these embodiments, at least one of the waste stream comprising plastic, the beneficiated plastic feedstock and/or the formed hydrocarbon product may optionally be analyzed by various methods or apparatus to determine characteristics of the plastic, including, for example, chemical composition, weight, density, volume, and/or mass. These characteristics may be evaluated before the plastic material is altered or compressed, so that processing parameters specific to the type and quantity of plastic can be determined and optimized.

Another aspect of the invention is a formed hydrocarbon product prepared by the methods of the present invention. In a specific embodiment, the formed hydrocarbon product contains at least one plastic resin selected from the group consisting of polypropylene, nylon6, polyethylene, nylon 6 and nylon-6,6, polyethylene terephthalate, and polypropylene and having a skeletal density between about 50 lbs/ft³ (800 kg/m³) and about 65 lbs/ft³ (1040 kg/m³). In a specific embodiment, the formed hydrocarbon product contains at least one inorganic compound selected from calcium carbonate, magnesium carbonate, magnesium silicate and barium sulfate, in an amount less than about 10% by weight. In one embodiment, the content of at least one inorganic compound selected from calcium carbonate, magnesium carbonate, magnesium silicate and barium sulfate, in the formed hydrocarbon product is less than about 3%, by weight.

In some embodiments, the formed hydrocarbon product is physically formed to a shape that best suits the geometry and thermodynamics of a system utilized by the purchaser or end user of the compressed hydrocarbon materials. For example, the physical form of the compressed hydrocarbon material can control or modify the thermodynamics of subsequent melting and gasifying processes conducted using the compressed hydrocarbon materials. In one embodiment, the compressed hydrocarbon material is formed to substantially have the shape of a cube. In another embodiment, the compressed hydrocarbon material has been formed to substantially have the shape of a log having a length of between about 10 inches and 20 inches.

In another embodiment, the hydrocarbon feedstock is formed into a pellet. In the case of pellets, the pellets are formed when extrudate is emitted as spaghetti strips that flow down a water cooled, channeled ramp into a rotating head that cuts them into lengths closely equal to their cross sectional dimensions.

All publications, patents, and patent documents cited herein are incorporated by reference herein, as though individually incorporated by reference. The invention has been described with reference to various specific and preferred embodiments and techniques. However, it should be understood that many variations and modifications may be made while remaining within the spirit and scope of the invention.

It is appreciated that certain features of the invention, which are, for clarity, described in the context of separate embodiments, may also be provided in combination in a single embodiment. Conversely, various features of the invention that are, for brevity, described in the context of a single embodiment, may also be provided separately or in any sub-combination.

The invention now being generally described will be more readily understood by reference to the following examples, which are included merely for the purposes of illustration of certain aspects of the embodiments of the present invention. The examples are not intended to limit the invention, as one of skill in the art would recognize from the above teachings and the following examples that other techniques and methods can satisfy the claims and can be employed without departing from the scope of the claimed invention.

### EXAMPLES

A series of laboratory tests was conducted in order to evaluate the principal questions concerning product quality stemming from the use of scrap carpeting feed stream materials. The principal quality questions answered were:

a) whether calcium carbonate, an inert contaminant, can be removed from carpet waste to a sufficient degree, and

b) whether the remaining plastic material will have high enough proportions hydrocarbons suitable for syncrude production.

A series of laboratory tests together with processing of increasingly larger samples of a formed hydrocarbon product in a syncrude production system (the AGILYX™ system, described, for example, in U.S. Patent Publication No. 2012/0024686, which is incorporated herein, in its entirety) demonstrated that the carbonate present could be reduced to an acceptable degree, approximately seven percent of mass, through the use of commercially available equipment. Syncrude yield was determined to be 68% by a full-scale production test of this material in a plant in Tigard, Oreg.

a) Calcium Carbonate Removal

The carpet waste consisted of three principal plastic resins: polypropylene (PP), nylon6 and nylon-6,6, and polyethylene terephthalate (PET), together with Calcium Carbonate (CaCO₃), an inert material used in combination with latex to form the secondary backing of carpets. The recycling of post-consumer waste carpet has led to the development of equipment specialized for shredding carpets and for separating the carpet fiber from the carbonate. One hundred pounds of carpet edge trimmings were shredded and size-reduced by hammer milling. No removal of calcium carbonate was performed on this material. Independent analysis reported a calcium carbonate mass fraction of 34% (see Table 1). The tests conducted included: 1) Gravimetric Analysis by selective dissolution, 2) Fourier Transform Infrared Spectroscopy (FTIR), 3) Pyrolysis Mass Spectroscopy (PYMS).

TABLE 1
Carpet Test - No Inorganics Removal - Analysis
Results for Sample 1 (Rug)

| | Weight % of | |
|---|---|---|
| Solubility | Total Sample | FTIR Identification |
| HFIP Soluble | 25.67% | Polyethylene terephthalate |
| High-temp TCB Soluble | 39.90% | Polypropylene |
| Insoluble | 34.42% | Calcium Carbonate |

Summary of Results: Selective dissolution and gravimetric analysis found three major components in the sample. FTIR was then performed to identify the class of each of the individual fractions.

Ten tons of the edge trimmings were then shredded and hammer milled. Carbonate was removed in multiple stages consisting of step cleaners and cyclone air separators. Analysis of this material showed a residual carbonate mass fraction of 7 wt. %. Overall recovery of fiber from the raw material was 50% (see Table 2). Test Description: Submitted mixed carpet waste sample was analyzed for Calcium Carbonate (CaCO₃) using thermal gravimetric analysis (TGA). TGA measures weight loss and can be used to characterize calcium carbonate in a mixture wherein the decomposition of CaCO₃ occurs at a temperature distinct from the other components. CaCO₃ breaks up into carbon dioxide CO₂ (gas) and Calcium Oxide (solid) above 700° C. The amount of CO₂ released is 45% of the CaCO₃, so the weight loss at the decomposition point gives a measure of the total weight of CaCO₃ present. TGA analysis is run by ramping the temperature from ambient to 850° C. at a constant rate of 20° C./min with the sample enclosed in a nitrogen atmosphere. We analyzed several samples and calculated an average for the % of CaCO₃. Test Limitations: This method for analysis uses very small samples, usually about 10-15 mg. The carpet waste samples submitted were very heterogeneous. In sampling—if only the fiber portion of the waste is taken, little CaCO₃ will be found. Representative samples that appear to be approximately 50% fibers and 50% backing were used for this analysis. In some runs, larger than normal samples of up to 35 mg were used. It is evident that the sampling results emphasize the heterogeneous nature of the carpet waste sampled. But it is also apparent that the CaCO₃ content is probably less than 10%.

TABLE 2
Calcium Carbonate Component Analysis in Mixed Carpet Waste

| Run | Initial Sample Size (mg) | % CaCO₃ |
|---|---|---|
| 1 | 13.3 | 14.8 |
| 2 | 15.9 | 4.51 |
| 3 | 17.5 | 11.29 |
| 4 | 13.4 | 2.79 |
| 5 | 15.0 | 3.69 |
| 6 | 35.7 | 3.55 |
| 7 | 12.3 | 9.40 |
| 8 | 11.9 | 6.59 |

Average (8 runs) = 7.07%

Processing of feedstock samples in the AGILYX™ system can provide the required level of confidence in assessing the suitability of feedstock for the production of synthetic crude oil. Samples of the first 100 lb shredded and hammer milled fiber were examined and determined to be suitable to move to preliminary testing in AGILYX™ system.

As delivered, the light and fluffy, shredded and hammer milled material has a bulk density of about 4.5 lbs/ft³, which is too low to be representative of production conditions. Bales of this fiber were compressed into cubes, yielding a bulk density of about 16 lbs/ft³, considered suitable for production testing.

b) Preliminary tests in the production facility included the use of four plastic to syncrude converters operating in a continuous round robin cycle. Preliminary tests used only one of the four converters, thus the produced syncrude stream contains the output from materials other than that under test. Hence, the preliminary tests provided information on the degree of convertibility of the test feedstock, primarily the type and quantity of char produced, but did not provide information on the quality of the syncrude nor its yield from the test feedstock. Determining quality and yield requires the subsequent stage of testing, a full production run in which all of the converters of the plant are processing the test material.

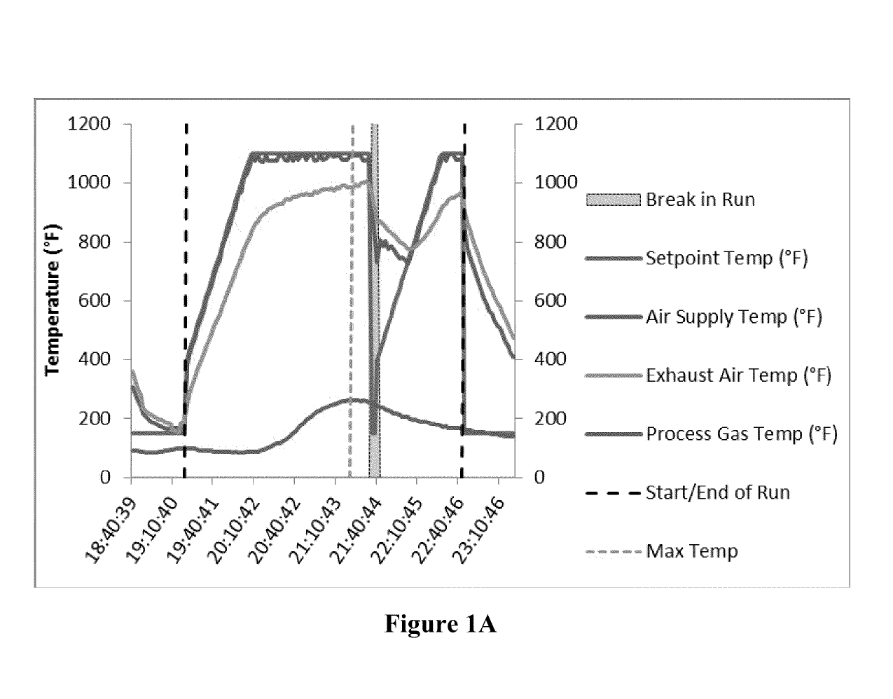

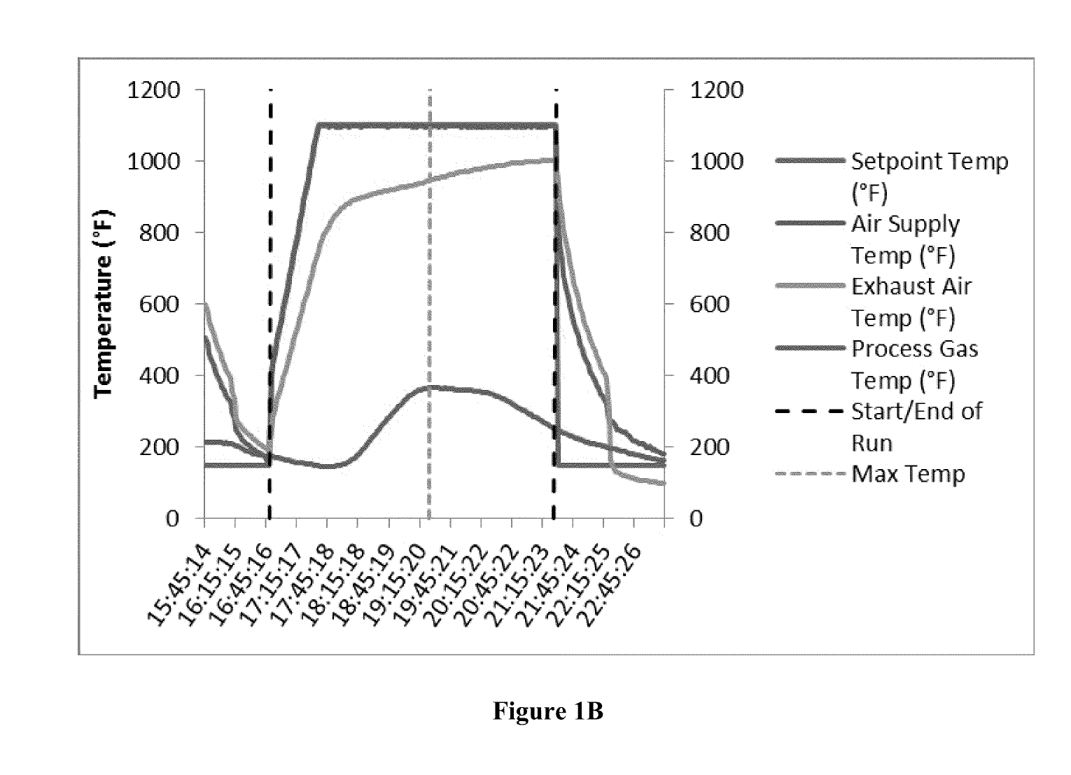

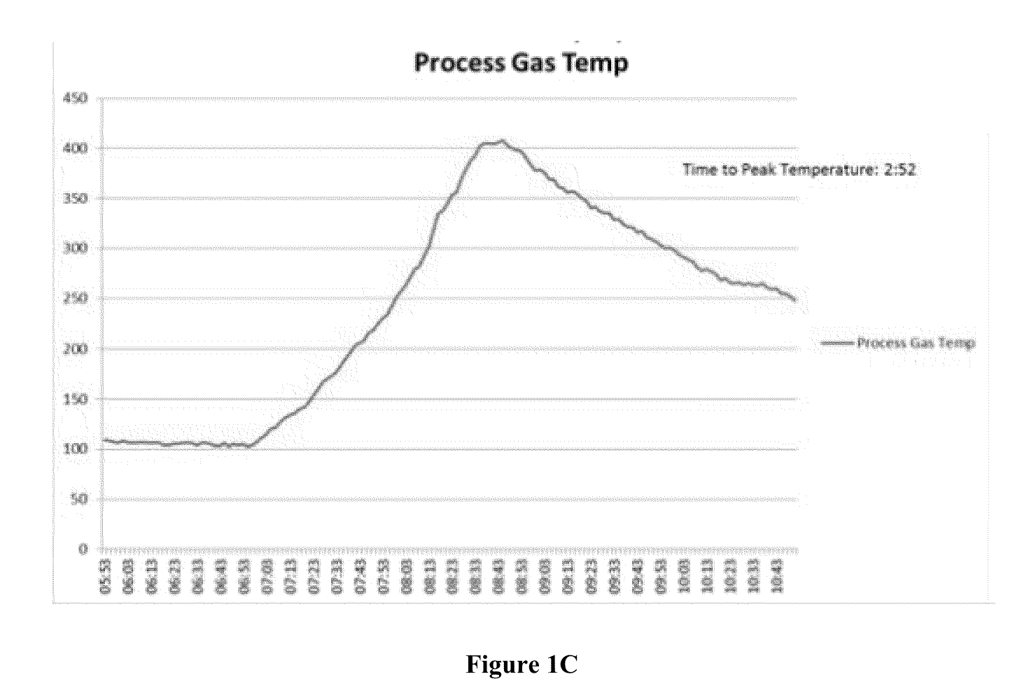

Four preliminary test runs showed that the shredded and hammer milled and compressed material produced acceptable char fractions and converted quickly (see FIGS. 1A, 1B, and 1C, showing the test results for all four test runs). FIG. 1A shows the gasification graph for a test run using the shredded, hammer milled and compressed material formed in the shape of logs. The machine load weight was 42 lbs, the run time was 3:16:06, the max temperature was: 263° F., and the time to max temperature was 2:02:03. FIG. 1B shows a gasification graph for a test run using the shredded, hammer milled and compressed material formed in the shape of logs and cubes. The machine load weight was 367 lbs, the run time was 4:38:08, the max temperature was: 366° F., and the time to max temperature was 2:34:04. FIG. 1C shows the process gas temperature chart for the test run using the shredded, hammer milled and compressed material formed in the shape of cubes only. The load weight was 571 lbs, the char weight was 32 lbs, the char percentage was 5.6%, the process time was 4:54 and the time to max temperature was 2:52. The char fraction was found to be acceptable and the char was dry, sandy, and without tar, therefore making the cleaning of the converters easy.

c) Production Test

A production test was conducted, consisting of six loads of the shredded, hammer milled and compressed material. Because the facility used consists of four AGILYX™ converters, the use of six loads ensured that all of the gas from other material had been purged from the system so that all of the syncrude produced by the system during the test could come exclusively from the tested feedstock.

The averaged results demonstrated that 68% by weight of the output consisted of syncrude, 15% was char, and 17% was non-condensable gasses.

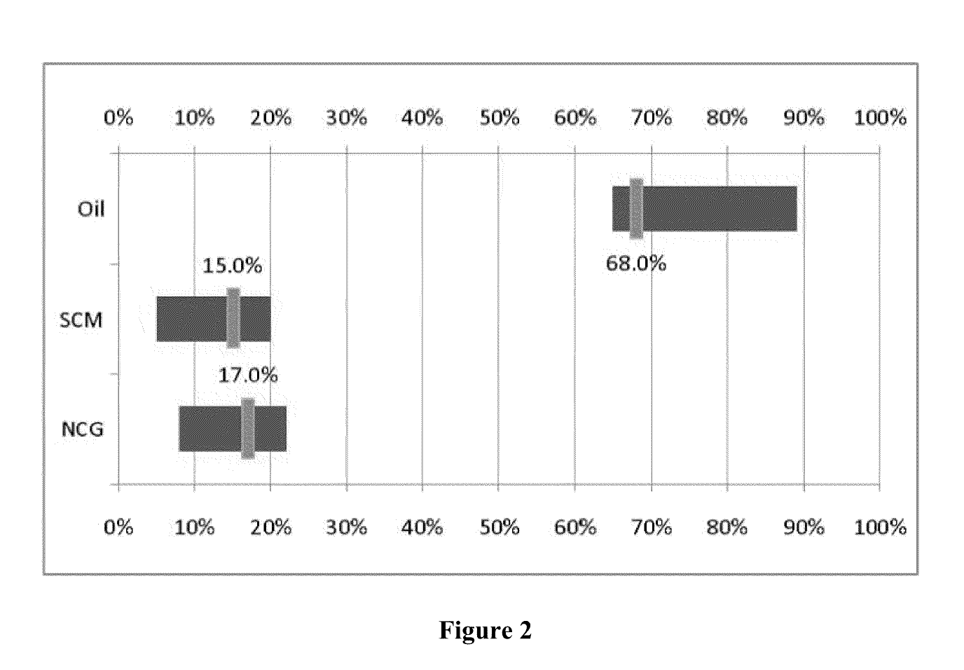

FIG. 2 shows the overall results of all six tests recorded (represented by vertical bar on the graph of FIG. 2). The feedstock was carpet tailings, the total weight of plastic processed was 3803 lbs and the total runs conducted was six. The range of the results shows in FIG. 2A represents the average results in the AGILYX™ system. Process metrics indicate an oil yield of 68% by weight. At 6.8 lbs/gallon, production of approx. 385 gallons of oil in six runs is assumed. The solid carbon material recovered was 550 lbs or approx 15%, by weight. The non-condensable gases were measured to be 631 lbs or approximately 17% by weight.

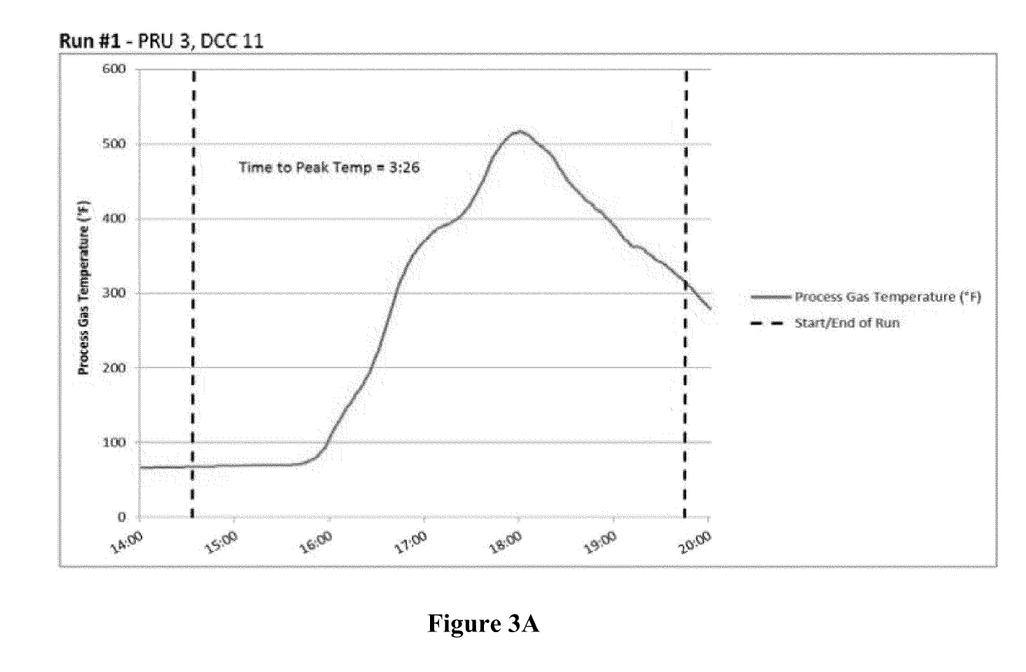

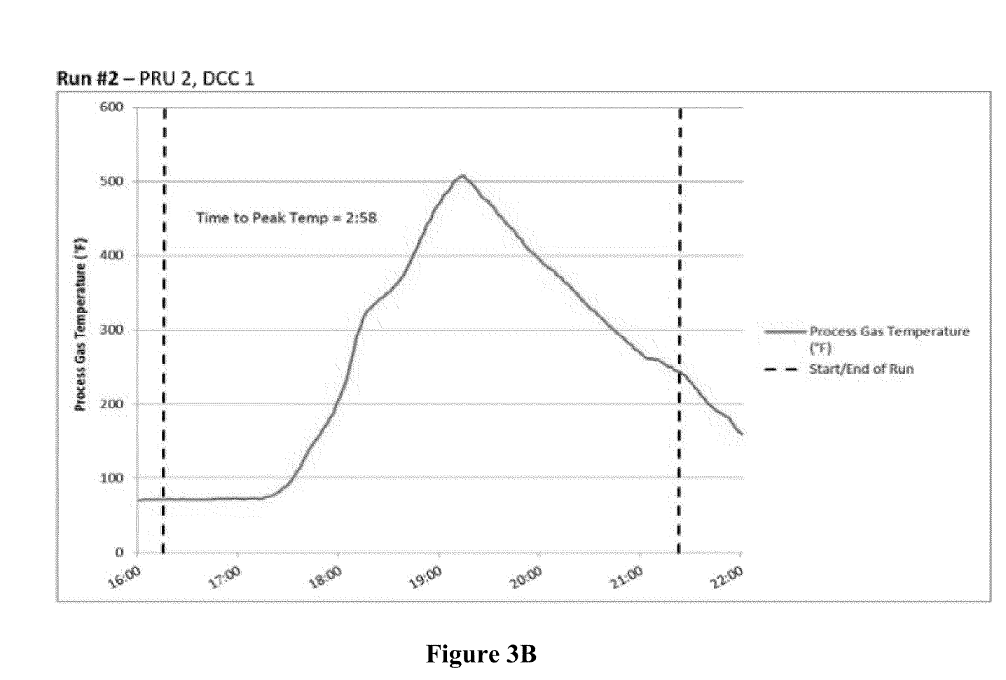

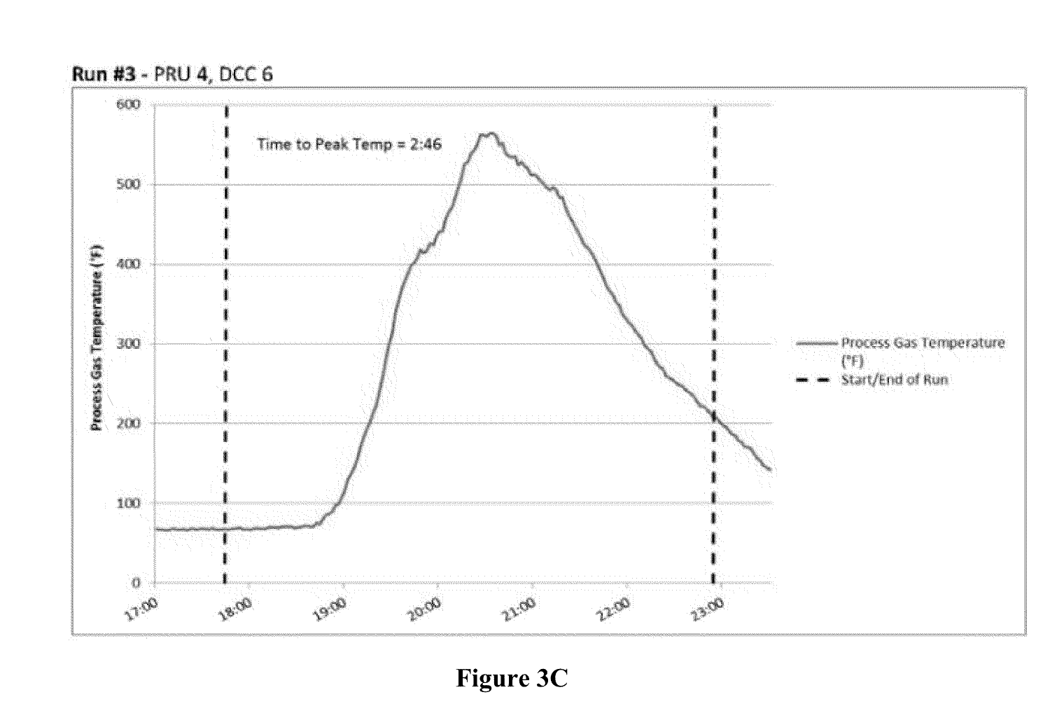

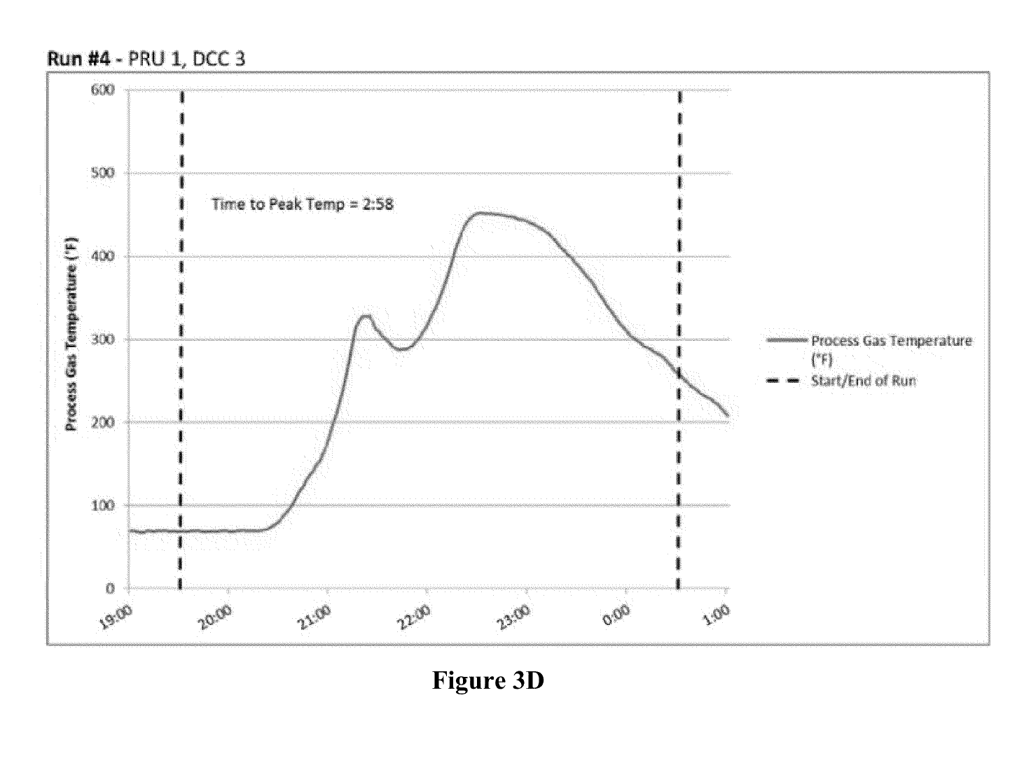

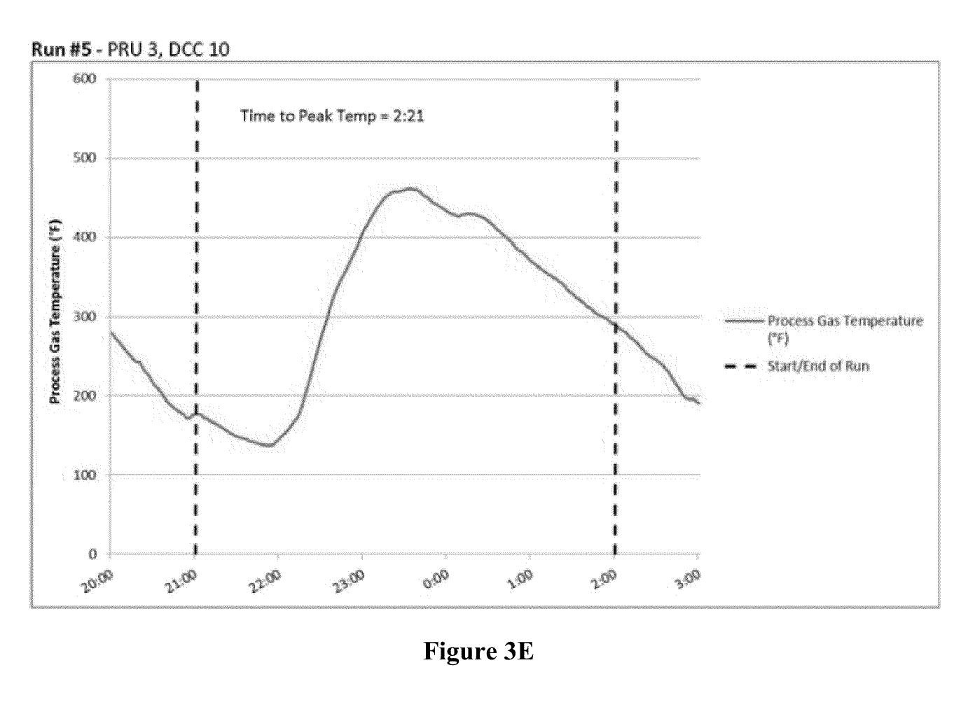

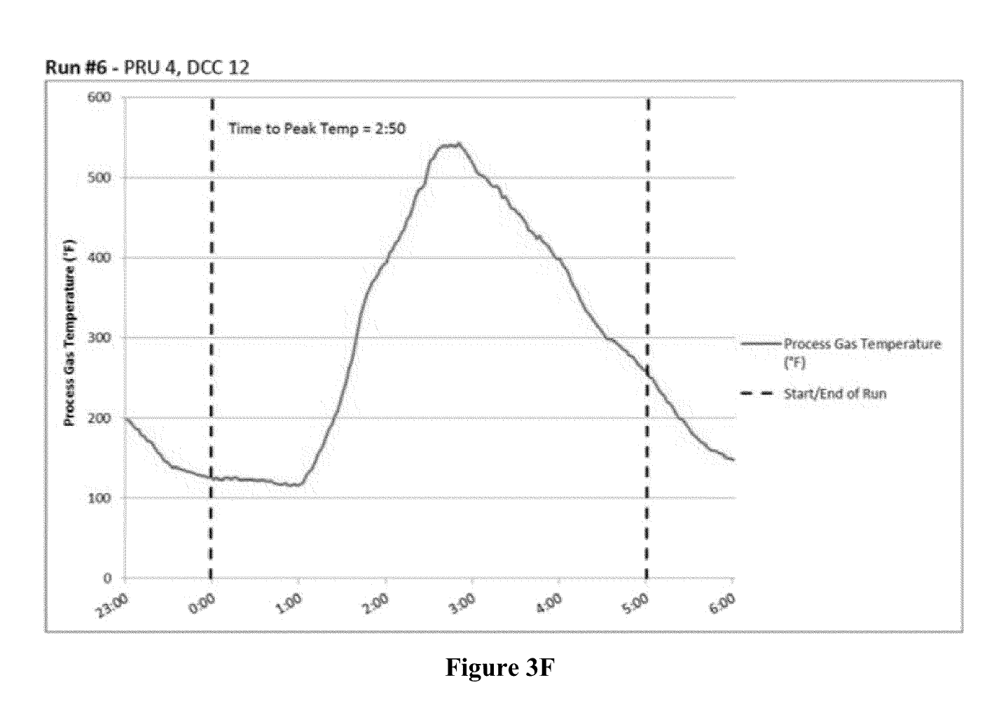

FIGS. 3A-3F shows gasification graphs representing the gasification time and temperature from each run during these six tests. The results of the six runs are summarized in the following Table 3:

TABLE 3
Summary of Test Results

| | | Load Weight | Char Weight | |
|---|---|---|---|---|
| PRU | DCC | (lbs) | (lbs) | Char % |
| 3 | 11 | 756 | 103 | 13.62% |
| 2 | 1 | 675 | 82 | 12.15% |
| 4 | 6 | 632 | 89 | 14.08% |
| 1 | 3 | 654 | 107 | 16.36% |
| 3 | 10 | 456 | 74 | 16.23% |
| 4 | 12 | 630 | 95 | 15.08% |

Within the uncertainties of measurement as stated in their report, these values lie within normal ranges. AGILYX™ points to the relatively sharp peaks of the heating curves, and the relatively short time to reach those peaks as indicating, along with the dry and easily managed char, that this material is a preferred feedstock.

2. Feedstock Quantity

The principal question concerning feedstock quantity is whether the carpet fiber can be made sufficiently dense to produce economically viable production yields, and whether at the needed density the material processes efficiently and economically in the AGILYX™ system. A series of tests subsequent to the production test reported above confirmed that both objectives have been achieved, but that economic viability requires the highest achievable material density.

The production test load weights ranged from 456 to 1100 lbs. Although suitable for system testing, these weights are too low to produce economically viable yields, which require loads greater than 2000 lbs. The test used fiber compressed into cubes at an average bulk density of 16 lbs/ft³. Logs were also produced from these cubes compressed to a unit density ranging from 32-38 lbs/ft³. Logs produced by extrusion at a unit density of 63 lbs/ft³ were also tested in the AGILYX™ system. All densified forms were found to convert quickly and cleanly relative to their normal cycle times, and char conditions. The load weights that the densest logs could produce are sufficient to be economically viable in production as they are equivalent to the actual density of the plastic constituents of carpet fiber, approximately 62 lbs/ft³.

Because the log-densified form of the carpet fiber was found to convert successfully, higher densities were explored via extrusion. A test was conducted in conjunction with the Composite Materials and Engineering Center at Washington State University. This work determined that the fiber could be extruded at densities ranging from to 56-60 lbs/ft³ and in sizes suitable for use in the AGILYX™ system (see Table 4). Logs of the extruded material about fifteen-inches long and four inches wide and four inches in height have been tested in the AGILYX™ system in increasingly greater load weights and found to convert cleanly and at the same cycle times as previously observed. Load weights of this extruded material would range from 2200-2800 lbs, depending on extruded density and loading configuration.

### Test Description:

Extrusion processing procedures and results for trials conducted at WSU Composite Materials and Engineering Center, assessing ability to extrude carpet fibers into solid profiles for use as fuel feedstock.

### Extrusion Feed Details:

Initial feeding of the carpet fiber was done with a modified crammer screw designed to pull fibers into the feed throat of the extruder. After initial testing, the trial was considered a failure and other protocols were proposed. The next attempt was to feed the pulled fiber by hand into the feed throat of the 86 mm counter-rotating conical twin-screw extruder. This worked with some success. However inconsistent feeding caused surging and sporadic performance. To improve the feed-ability and achieve a steady-state flow of material into and through the extruder, the carpet fibers were pelletized using a ring die pellet mill. The pelletized fiber had a bulk density of approximately 20 lbs/ft³ and was then fed into the extruder and the steady state flow was achieved.

### Die Details:

The initial die used was a short land 1.5″ diameter solid profile. This profile ran pretty well on the loose fiber, however, some surging and interrupted flow did occur. A larger profile was needed for the final product. Therefore, we switched to a 3.5″ square solid profile. This was run with both loose fiber and pelletized fibers, with the latter getting the best results.

### Extruder Temperature Profile:

Temperature profiles for the barrel zones (BZ) of the extruder and the die zones (DZ) are provided. The zone numbering scheme starts in the feed throat of the extruder and the die zone starts at the screw tips. These screw temperatures were not included in this due to their inability to heat at this time. Screw rate was kept between 5-10 rpm throughout the trial, while melt pressures ranged from 150 to 800 psi depending upon temperature and rate. The temperature profiles of 4 and 5 were found to run the best. To expedite the trial process, a commercial lubricant (Strucktol TPW 104) was added to the pelletized carpet at a 3% level to help improve the extrusion process. However, a rough surface and an overall profile larger than the output die profile was observed throughout much of the trial.

TABLE 4
Carpet Extrusion Trial Report

| Temp | Extruder temperatures | | | | Die temperatures | | | |
|---|---|---|---|---|---|---|---|---|
| profile | (° F.) | | | | (° F.) | | | |
| (TP) | BZ1 | BZ2 | BZ3 | BZ4 | DZ1 | DZ2 | DZ3 | Comments |

Loose fiber

| | | | | | | | | |
|---|---|---|---|---|---|---|---|---|
| 1 - 1.5 | 510 | 500 | 400 | 380 | 350 | 350 | 350 | Ran well |
| diam die | | | | | | | | |
| 2 - 3.5 | 510 | 500 | 400 | 280 | 350 | 350 | 350 | Inconsistent feed |
| sq. die | | | | | | | | |

Pelletized fiber

| | | | | | | | | |
|---|---|---|---|---|---|---|---|---|
| 3 - 3.5 | 525 | 515 | 420 | 375 | 375 | 350 | 350 | Too hot - low melt integrity |
| sq. die | | | | | | | | |
| 4 - 3.5 | 490 | 450 | 400 | 370 | 350 | 375 | 360 | Cold, but ran - 3% lubricant |
| sq. die | | | | | | | | added |
| 5 - 3.5 | 520 | 500 | 450 | 370 | 350 | 350 | 350 | Better than before, but starting to |
| sq. die | | | | | | | | lose integrity - 3% lubricant |
| | | | | | | | | added |

### Results Summary:

the density of the product obtained in TP 4 and 5 averaged around 56 lb/ft³. This product was extruded at 7 rpm with a melt temperature between 250-300 psi, amperage loading of 5%, and a screw thrust of 4%. All of these parameters were quite low, indicating low power output, but also much room for improvement in the die design and final product shape and density. And increased density would likely be observed with a die machined specifically for this polymer type.

The following outlines the extrusion processing procedures and results for the recent trial A trial was conducted at Washington State University's Composite Materials and Engineering Center to assess the ability to extrude carpet fibers into a solid profile to be used for a fuel feedstock in the AGILYX™ system. Carpet fiber comprising plastic materials was supplied as compressed bales. The compressed bales were pelletized using a pellet mill with a one-quarter inch diameter (bulk density of approximately 20 lb/ft³). To improve the surface quality, a commercial lubricant (Strucktol TPW 104) was added to the pelletized carpet at 5 wt. %. The compressed pellets were fed into an 86 mm conical twin-screw extruder at the temperatures listed in Table 5, for the barrel zones (BZ) and die zones (DZ). A solid 3.5 inch square solid profile die was used to shape the product into its final dimension. Screw rate was kept between 8-12 rpm's throughout the trial, while melt pressures were in the range of 375 psi.

TABLE 5
Exemplary Extruder Temperatures for Compressed Pellets

| | |
|---|---|
| Extruder temperatures | Die temperatures |
| (° F.) | (° F.) |

| BZ1 | BZ2 | BZ3 | BZ4 | DZ1 | DZ2 | DZ3 |
|---|---|---|---|---|---|---|
| 530 | 515 | 450 | 370 | 375 | 375 | 360 |

The density of the product obtained was approximately 63.6 lb/ft³ as measured in a water immersion test. Approximately 1,100 lbs of the extruded material was cut to 15 and 7.5 inches and used for test processing in the AGILYX™ system.

### MSW Trial

To extend the verification of the utility of the present invention, two tests of plastics derived from municipal solid waste (MSW) were conducted. The principal objectives of the first test, conducted at the Composite Materials and Engineering Center at Washing State University, were 1) to confirm that coarsely shredded heterogeneous plastics could be introduced successfully to an extruder without the pelletizing step described above for carpet fibers; and 2) that the extruded product was suitable for use as a feedstock in the AGILYX™ system. Both objectives were achieved.

Using a different source of waste plastic, a second test of municipal solid waste (MSW) plastics was also conducted, this one at a commercial plastic recycling company. The objectives of this test were: a) to assess the performance of a rammer-stuffer attached to the extruder in maintaining an even flow of heterogeneous and variously sized mixed plastics; and b) to produce pellets of a density and size desired by Agilyx for use in their system. Both objectives were achieved.

In addition, we determined that exclusion of less desirable plastics from the produced feedstock could be achieved at multiple stages of the preparation and densification process.

### 3. Product Quality

The synthetic crude oil product must meet quality standards imposed by the refiner receiving the oil. Oil from the production runs have been saved for future chemical assay. All of the output from the test and all other test runs were accepted by the refiner, US Oil and Refining in Tacoma, Wash.

In addition, the carpet fiber introduced no new contaminates to the char byproduct, nor did it alter its physical form in any way that prevented its use as a secondary fuel in smelting, the current destination of char from the AGILYX™ system.

Feedstock quality: Prior to the test work described here, carpet fiber was regarded as an unsuitable feedstock for pyrolysis based conversion systems. Largely, this is due to the presence of the calcium carbonate secondary backing. Initially, analysis of the use of this carpet scrap material as a potential feedstock was regarded with skepticism, both because of the received wisdom in the field, and because of the significant presence of nylon in carpet fiber, a plastic that was assumed would convert at low efficiency. The results of this evaluation program, however, show the carpeting feedstock quality to be acceptable.

Feedstock quantity: Our success in making waste carpet a suitable, even excellent, feedstock in pyrolysis processes, however, comes at a high price in preparation. This means that densification to achieve higher load weights is needed in order to increase the production yield and annual revenue of the facility beyond anticipated models. Further, successful conversion of large, dense forms had not previously been demonstrated in the AGILYX™ system, and ran contrary to the theory of system thermodynamics set forth for the AGILYX™ system. These results confirm that successful conversion of highly densified forms of plastics is achieved in the AGILYX™ system, but that for carpets at least, throughput rates roughly twice as great as the normal rate in the AGILYX™ system are needed to make the production facility economically successful.

The foregoing examples of the present invention have been presented for purposes of illustration and description. Furthermore, these examples are not intended to limit the invention to the form disclosed herein. Consequently, variations and modifications commensurate with the teachings of the description of the invention, and the skill or knowledge of the relevant art, are within the scope of the present invention. The specific embodiments described in the examples provided herein are intended to further explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A method of treating waste materials comprising:
altering a waste stream comprising plastic to produce a beneficiated plastic feedstock;
compressing the beneficiated plastic feedstock to form a compressed hydrocarbon material; and,
forming the compressed hydrocarbon material to produce a formed hydrocarbon product.

2. The method of claim 1, wherein the waste stream comprising plastic contains at least one plastic selected from the group consisting of acetals, acrylics, acrylonitrile-butadiene-styrene, alkyds, coumarone-indene, diallyl phthalate, epoxy, fluoropolymer, melamine-formaldehyde, nitrile resins, nylons, petroleum resins, phenolics, polyamide-imide, polyarylates, polybutylene, polycarbonate, polyethylene, polyimides, polyphenylene oxide, polyphenylene sulfide, polypropylene, polystyrene, polyurethanes, polyvinyl acetate, styrene acrylonitrile, styrene butadiene latexes, sulfone polymers, thermoplastic polyester, unsaturated polyester, urea-formaldehyde, hexachloroethane, polyethylene terephthalate, high density polyethylene, low density polyethylene, and combinations thereof.

3. The method of claim 1, wherein the waste stream comprising plastic contains waste carpet including at least one of post-consumer carpeting, post-industrial carpet scrap, and mixtures thereof.

4. The method of claim 1, wherein the waste stream comprising plastic is provided in at least one of a vertical feed hopper, a vibrating hopper, a crammer hopper, a vacuum hopper, a progressive cavity pump, a single screw extruder, a twin-screw extruder, and combinations thereof.

5. The method of claim 1, wherein the altering step comprises separating an inorganic component from the waste stream comprising plastic.

6. The method of claim 1, wherein the altering step comprises comminuting the waste stream comprising plastic.

7. The method of claim 1, wherein the altering step comprises at least one of shredding, crushing, and the milling the waste stream comprising plastic.

8. The method of claim 1, wherein the altering step comprises sorting components of the waste stream comprising plastic into at least two separate feed streams based on a physical parameter selected from size, weight, volume, density, and combinations thereof.

9. The method of claim 1, wherein the altering step comprises removing at least one organic contaminant from the waste stream comprising plastic.

10. The method of claim 1, wherein the altering step comprises at least one of washing, rinsing, and spraying the waste stream comprising plastic with a composition comprising water.

11. The method of claim 1, wherein the compressing step comprises applying a supplemental heating source to the compressing device.

12. The method of claim 1, wherein the compressing step comprises venting gas from the beneficiated plastic feedstock being compressed.

13. The method of claim 1, wherein the compressing step is conducted in at least one of a roll press, a mechanical ram, a crammer hopper, a vacuum hopper, a progressive cavity pump, a single screw extruder, a twin screw extruder, and combinations thereof.

14. The method of claim 1, wherein the compressing step comprises extruding the beneficiated plastic feedstock in and extruder to form a compressed hydrocarbon material.

15. The method of claim 14, wherein the extruder is a conical, twin-screw, counter-rotating extruder.

16. The method of claim 14, wherein the extruder comprises at least one heating zone wherein external heat is applied to the beneficiated plastic feedstock undergoing extrusion.

17. The method of claim 14, wherein the extruder comprises a die.

18. The method of claim 17, wherein the die shapes the compressed hydrocarbon material as it exits the extruder, into a cross sectional shape selected from circular, oval, square, rectangular, and trapezoidal.

19. The method of claim 1, further comprising adding a first additive to the beneficiated plastic feedstock prior to compressing the beneficiated plastic feedstock, wherein the first additive is selected from a polyethylene, a polypropylene, a wax, a paraffin, a mineral oil, a vegetable oil, a silicone, and combinations thereof.

20. The method of claim 19, further comprising adding a second additive to the beneficiated plastic feedstock, wherein the second additive is selected from the group consisting of a plastic, an inorganic compound, biomass, and a combination thereof.

21. The method of claim 20, wherein the second additive is selected from the group consisting of bagasse, wheat straw, corn stover, dried distiller grain solids, spent fermentation broth, saw dust, and a combination thereof.

22. The method of claim 1, wherein the forming step comprises at least one of chopping, cutting, pelletizing, shaving, slicing, chipping, comminuting, granulating, and a combination thereof.

23. The method of claim 1, wherein the forming step is conducted with at least one of a pelletizer, a chipper, email, a knife, and a combination thereof.

24. The method of claim 14, wherein the forming step comprises cutting the compressed hydrocarbon material exiting the extruder to obtain a formed hydrocarbon product.

25. The method of claim 1, further comprising cooling the compressed hydrocarbon material in the cooling medium comprising at least one of water and air.

26. The method of claim 1, further comprising thermally degrading the formed hydrocarbon product to form carbon containing product selected from a solid, a crude oil, and a synthesis gas.

27. The method of claim 26, wherein the thermal degradation comprises heating the formed hydrocarbon product in the presence of diatomic oxygen.

28. The method of claim 26, wherein the thermal degradation comprises heating the formed hydrocarbon product in the absence of diatomic oxygen.

29. The method of claim 1, wherein the formed hydrocarbon product has a higher density than the waste stream comprising plastic.

30. The method of claim 1, wherein the formed hydrocarbon product has a higher thermal conductivity than the waste stream comprising plastic.

31. A method of treating carpet waste comprising:
altering a stream of carpet waste by shredding the carpet waste and removing at least one inorganic material selected from the group consisting of calcium carbonate, magnesium carbonate, barium sulfate, and magnesium silicate, to produce a beneficiated plastic feedstock;
extruding the beneficiated plastic feedstock in and extruder to form a compressed hydrocarbon material having a unit density between about 50 lbs/ft³ (800 kg/m³) and about 65 lbs/ft³ (1040 kg/m³); and,
shaping the compressed hydrocarbon material by cutting the compressed hydrocarbon material has it exits the extruder to produce a formed hydrocarbon product in the shape of a log.

32. A compressed hydrocarbon material comprising at least one plastic resin selected from the group consisting of polypropylene, nylon6, polyethylene, nylon 6 and nylon-6,6, polyethylene terephthalate, and polypropylene, and having a unit density between about 50 lbs/ft3 (800 kg/m3) and about 65 lbs/ft3 (1040 kg/m3).

33. The compressed hydrocarbon material of claim 32, wherein the compressed hydrocarbon material has a shape of a log having a length of between about 10 inches and 20 inches.

34. The compressed hydrocarbon material of claim 32, wherein the compressed hydrocarbon material has a shape of a pellet.
